(19) United States
(12) Patent Application Publication
(10) Pub. No.: US 2008/0140577 A1
(43) Pub. Date: Jun. 12, 2008

(54) SEARCH AND COMPARISON SHOPPING ENGINE

(76) Inventors: Shahriar RAHMAN, San Jose, CA (US); Aniqa SHAMA, San Jose, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 11/952,899

(22) Filed: Dec. 7, 2007

Related U.S. Application Data
(60) Provisional application No. 60/869,027, filed on Dec. 7, 2006.
(60) Provisional application No. 60/869,005, filed on Dec. 7, 2006.
(60) Provisional application No. 60/869,036, filed on Dec. 7, 2006.
(60) Provisional application No. 60/974,788, filed on Sep. 24, 2007.

(51) Int. Cl. H04L 9/00; G06Q 30/00

(52) U.S. Cl. 705/71; 705/26

(57) ABSTRACT

In an example embodiment, an apparatus configured as a comparison shopping engines (CSE) and a shopping search engines (SSE). The apparatus enables a user to enter data about one or more products to purchase. The apparatus enables a user to purchase products from a plurality of vendors in a single transaction. The apparatus receives a single payment from the user which is distributed to the plurality of vendors. The apparatus can also be configured to allow a user to select a single shipper for the plurality of items and purchase shipping for the plurality of items in a single transaction. In addition, the apparatus provides for a product search that allows a user to specify certain optimization parameters and runs automatically for the user over a period of time. Also disclosed herein in an example embodiment, is a system for secure online proxy payments.

### CROSS-REFERENCE TO RELATED APPLICATIONS

This application claims the benefit of priority of U.S. Provisional Application No. 60/869,027 filed Dec. 7, 2006, U.S. Provisional Application No. 60/869,005 filed Dec. 7, 2006, U.S. Provisional Application No. 60/869,036 filed on Dec. 7, 2006, and U.S. Provisional Application No. 60/974,788 filed on Sep. 24, 2007.

### FIELD OF INVENTION

The invention relates generally to online shopping search and comparison shopping, particularly when performed in a networked environment, e.g. Internet and World Wide Web (WWW).

### BACKGROUND

The first Internet shopping sites started in the mid-90s with a model where consumer products were merchandised and sold on the company's website and the products were subsequently shipped to the customers from inventory stocked in fulfillment centers either owned by the sites or their partners. Towards the end of the 90's a new breed of websites cropped up-price comparison (or comparison shopping) sites that simply compared prices from various traditional e-commerce sites (or E-tailers) for any given product. A customer visiting one of these new sites was able to search for products in various categories and compare prices for those products at various E-tailers. Since most E-tailers had affiliate programs that offered attractive commissions to websites that sent purchasing customers their way, the most popular business model for price-comparison sites was to join the affiliate programs of all the E-tailers and generate revenues from customer clicks on their price comparison pages, which directly led to the E-tailers' websites. The affiliates programs and pay-per-click (PPC) revenue streams still is the most popular business model.

After the year 2000, there has been a steady growth in the number of traditional e-commerce sites. As Internet usage, broadband penetration as well as Internet penetration into mobile and handheld devices grew, so did the profitability of E-tailers. Today, there are thousands of such websites that sell everything from sandwiches to books to real estate. The number is expected to grow. With the growth in the number of e-tailing sites, price comparison gained significant prominence and has become an essential step in the online shopping process of many customers.

In November 2006, over 50 million consumers used comparison shopping sites to search for the best deals on the Internet. Some of the larger comparison shopping sites have upwards of hundreds of millions of dollars in Gross Merchandise Sales. With this growth, the business model also evolved. Popular comparison shopping sites have started charging merchants for prominent placement of their products. This has further helped improve the profitability of the price-comparison sites.

In spite of this tremendous growth in business, few price-comparison sites have offered any significant new features to their shopping customers. Almost all comparison shopping sites help customers find the cheapest merchant to buy a single product from, some with shipping and taxes included. For example, Shopping.com, a popular comparison shopping site can provides the best price for a Sony LCD monitor with shipping and taxes across many merchants. Nextag.com, another popular comparison shopping site provides bottom-line prices and provides price history over some period of the past. Pricegrabber.com, yet another popular comparison shopping site provides means for browsing through some holiday gift ideas and merchant coupons and rebates. More recently, Jellyfish.com provides means for reverse-auction based price comparison in an attempt to eliminate PPC models towards a more suitable Pay-per-Sale (PPS) model.

With advent of WEB2.0 and related technologies, online shopping behavior is shifting dramatically and shopping search engines as well as comparison sites are increasingly influenced by user-generated and user-driven contents. For example, a shopper willing to buy a backpack may like to search, compare and choose one based on her preferences and interests. She may wish to read through all relevant information about the possible candidates, such as manufacturer, list of E-tailers, reviews, recommendations, images, videos, promotional materials for each of them prior to choosing a single E-tailer to purchase from. In other words, price is no longer the single motivation for an online shopper to choose a particular E-tailer.

Most comparison shopping engines (CSEs) and shopping search engines (SSEs) on the market today index merchant offerings and display the indexed hyperlinks to a shopper. This is problematic due to a number of reasons. First, it forces a visitor to transition out of the CSE/SSE following the hyperlinks of search results or browse product or service entries. Re-directing shoppers to an external site is undesirable for a CSE from a stickiness perspective on CSE as it causes a user to spend only a fractional time of her online shopping on the CSE site itself. Second, re-direction causes a shopper to browse back and forth between the CSE/SSE and E-tailer sites and between different E-tailer sites during her research and much time is spent in sorting and analyzing various sources of shopping information in lieu of the actual product or service specific information. Third, each merchant is forced to independently manage and maintain the same product or service information, which is prone to repetition, duplication, inconsistency, cluttering and difficulty in maintaining information, as the products, services and information pertaining to them are constantly changing. Fourth, there are number of problems with the PPC model as described in US Patent Publication 2007/0239560 by M. McGuire, et al. Fifth, if a user wishes to purchase items from multiple E-tailers, she must do so by visiting each of them; provide payment and shipment information and make a separate purchase with each E-tailer. This model increases the purchase complexity linearly as a function of the number of E-tailers from whom items are purchased. This is clearly undesirable as well as unsecured as shopper's payment credentials must be shared and/or transmitted for each E-tailer.

### SUMMARY OF INVENTION

Described herein in an example embodiment is an apparatus that comprises a first interface configured to communicate with a first and second vendor, a user interface configured to receive data and output data, and logic coupled to the first interface and the user interface. The user interface is configured to receive data representative of a first product to purchase from a first vendor and a second product to purchase from the second vendor. The logic is responsive to the received data to determine a total payment amount for the first product and the second product. The logic is responsive to determining the total to have the total output on the user interface. The logic is responsive to receiving payment data from the user interface to distribute a payment to the first vendor and the second vendor.

Described herein in an example embodiment is an apparatus comprising a first interface configured to communicate with a first and second product vendors and first and second shipping vendors, a user interface configured to receive data and output data, and logic coupled to the first interface and the user interface. The logic is configured to receive data from the user interface representative of a first product to purchase from a first vendor and a second product to purchase from a second vendor. The logic is configured to output on the user interface to data representative of the first shipping vendor and the second shipping vendor. The logic is configured to receive data representative of a user selection of a selected shipping vendor selected from the group consisting of the first shipping vendor and the second shipping vendor. The logic is further configured to receive data from the user input for shipping the first and second products to a location. The logic communicates data for shipping the first product and the second product to the location to the shipping vendor.

Described herein in an example embodiment is an apparatus that comprises a first interface configured to communicate with a first and second vendor, a user interface configured to receive data and output data, and logic coupled to the first interface and the user interface. The logic is configured to receive data from the user interface representative of a product and at least one optimization parameter. The logic is configured to communicate with the first vendor to acquire first product data associated with the product available from the first vendor. The logic is configured to communicate with the first second to acquire second product data associated with the product available from the second vendor. The logic is configured to filter the first and second product data based on data representative of an optimization parameter received via the user interface.

In accordance with an example embodiment, disclosed herein is a system for secure online proxy payments. The system comprises a merchant device, a payment-authorizer device, and a proxy device. The merchant device sends a merchant Registration-Request to the payment-authorizer device, the merchant Registration-Request including merchant-credentials. The payment-authorizer device sends a merchant-key to the merchant device in a merchant Registration-Response. The proxy device sends a proxy Registration-Request to the payment-authorizer device, the proxy Registration-Request comprises proxy-credentials The payment-authorizer device sends a proxy-key in a proxy Registration-Response to the proxy device The merchant device sends a merchant-proxy Registration-Request to the proxy device, the merchant-proxy Registration-Request comprises a merchant-hash The proxy device sends a proxy-hash to the merchant device in a Registration-Response The proxy device sends a Merchant-Request to the payment-authorizer device that comprises a merchant-hash encrypted using the proxy-key. The proxy device receives a proxy-merchant-key from the payment-authorizer device in a Merchant-Response.

### BRIEF DESCRIPTION OF THE DRAWINGS

So that the manner in which the above recited features of an example embodiment can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is illustrates a block diagram of a network environment of an example embodiment.

FIG. 2 illustrates an example detailed block diagram of a CSE/SSE in accordance with an example embodiment.

FIG. 3 illustrates an example CSE shopping navigation page.

FIG. 4 is an example flowchart showing a process of online shopping with interactions between a user and a CSE/SSE.

FIG. 5 is an example SSE product search results page.

FIG. 6 is an example flowchart showing a method of keyword based shopping search on a SSE.

FIG. 7 is an example flowchart showing a method of physical and logical parameter based shopping search on a SSE.

FIG. 8 is an example flowchart showing a method of derived and user interest and preference based shopping search on a SSE.

FIG. 9 is an example flowchart showing a method of combined physical, logical, derived and user interest and preference based shopping search on a SSE.

FIG. 10 is an example flowchart showing a method of offline shopping search on a SSE.

FIG. 11 is an example flowchart showing a method of saving performed searches for a user.

FIG. 12 is an example flowchart showing a method of saving performed search results for a user.

FIG. 13 is an example of a CSE product showcase page.

FIG. 14a and FIG. 14b is an example of a flowchart showing a method of automated purchasing of a product or service from an E-tailer through a CSE.

FIG. 15a, FIG. 15b, FIG. 15c and FIG. 15d are flowcharts showing an example of a method automated payment process on a CSE.

FIG. 16 is a flowchart showing an example of a method of automated shipment process on a CSE.

### DETAILED DESCRIPTION

Described herein is a system, method and apparatus is provided for online shopping search, comparison, navigation and automated purchase. Those of ordinary skill in the art will realize that the following detailed description of an example embodiment is illustrative only and is not intended to be in any way limiting. Other embodiments of an example embodiment will readily suggest themselves to such skilled persons having the benefit of this disclosure. Reference will now be made in detail to implementations of an example embodiment as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

Reference in the specification to “one embodiment” or “an embodiment” or “an example embodiment” means that a particular feature, structure, or characteristic described in connection with the embodiment is included in at least one embodiment is of the invention. The appearances of the phrase “in one embodiment” or “in one or more embodiments” in various places in the specification are not necessarily all referring to the same embodiment, nor are separate or alternative embodiments mutually exclusive of other embodiments. Features and aspects of various embodiments may be integrated into other embodiments, and embodiments illustrated in this document may be implemented without all of the features or aspects illustrated or described.

In accordance with an example embodiment, the components, process steps, and/or data structures may be implemented using various types of operating systems, computing platforms, computer programs, general purpose machines, and/or logic. “Logic”, as used herein, includes but is not limited to hardware, firmware, software and/or combinations of each to perform a function(s) or an action(s), and/or to cause a function or action from another component. For example, based on a desired application or need, logic may include a software controlled microprocessor, discrete logic such as an application specific integrated circuit (ASIC), a programmable/programmed logic device, memory device containing instructions, or the like, or combinational logic embodied in hardware. Logic may also be fully embodied as software.

### Definitions

1. User: An individual who has registered in the system. Also known as a customer in context of online shopping.
2. Web Site (or ‘Site’ for short): A computer system that serves informational content over a network using a network protocol. Such a protocol may be standard and proprietary. One example protocol is Hyper Text Transfer Protocol (HTTP) which is used in World Wide Web (WWW) today. As used herein, the term is generally intended to encompass both (i) the hardware/software server components that serve the informational content over the network, and (ii) the “back end” hardware/software components, including any non-standard or specialized components, that interact with the server components to perform services for Web site users. (While this term is intended to refer to what is now commonly known as a Web Site, it is also intended to encompass variations that may be made in the future, including changes and additions to existing network protocols).
3. Internet: A collection of interconnected (public and/or private) networks that are linked together by a set of standard protocols (such as TCP/IP and HTTP) to form a global, distributed network. (While this term is intended to refer to what is now commonly known as the Internet, it is also intended to encompass variations that may be made in the future, including changes and additions to existing standard protocols).
4. Interface: Any mechanism by which an external individual or external computer can obtain and provide data, respectively to or from the database of an example embodiment. One common example of the interface is a web site. Other examples might include an e-mail message, a telephone voice message or a paper report.
5. Server: A software program, or the computer on which that program runs, that provides a specific kind of service to client software running on the same computer or other computers on a network.
6. Application server: A kind of server that usually hosts applications and runs them for users. In context of a CSE/SSE, applications are front-end, user-facing methods and implement user-desired shopping applications, such as search, navigation, and purchase.
7. Engine: A kind of server that usually hosts dedicated services needed by applications. In context of a CSE/SSE, engines are back-end methods that implement supporting functions for shopping applications, such as crawling, indexing and interacting with third party sites for automated buy, pay and ship.
8. Online Search: Search performed by a server (a.k.a. search engine) by explicitly interacting with a human user, where the server is most commonly online and accessible via the Internet/WWW. Online search can be basic keyword based or advanced keyword and query parameter based.
9. Shopping Search: An online or offline search performed specifically for shopping, i.e. with intention for eventual buying or selling.
10. Online Optimized Search: An online search process where the server allows a user to optimize search results based on user's interests, preferences, future plans, past history and the like.
11. Offline Search: Search performed by a server (a.k.a. search engine) without interacting with a human user, where the server performs the search on behalf of the user even when she is not connected to the server. Also known as Background Search or Persistent Search.
12. Online Auto-Buy: A server application and engine that allows human users to only specify the product or/and service along with purchase parameters and the server completes the purchase from any source on behalf of the user.
13. Online Auto-Ship: A server application and engine that allows human users to only specify the target address for shipment along with shipping parameters, e.g. shipper to be used and the server completes the shipment from any source to any destination on behalf of the user.
14. Online Auto-Pay: A server application that allows human users to only specify the payee for payment along with payment parameters and the server completes the payment to any party on behalf of the user.
15. Web Crawling (or ‘crawling’ for short): A program or automated script which browses the WWW in a methodical, automated manner.
16. Indexing: A method by which indexes are created based on key data fields or keywords so that when those data fields or keywords are used in online search, results can be returned very fast.

### Online Shopping Environment.

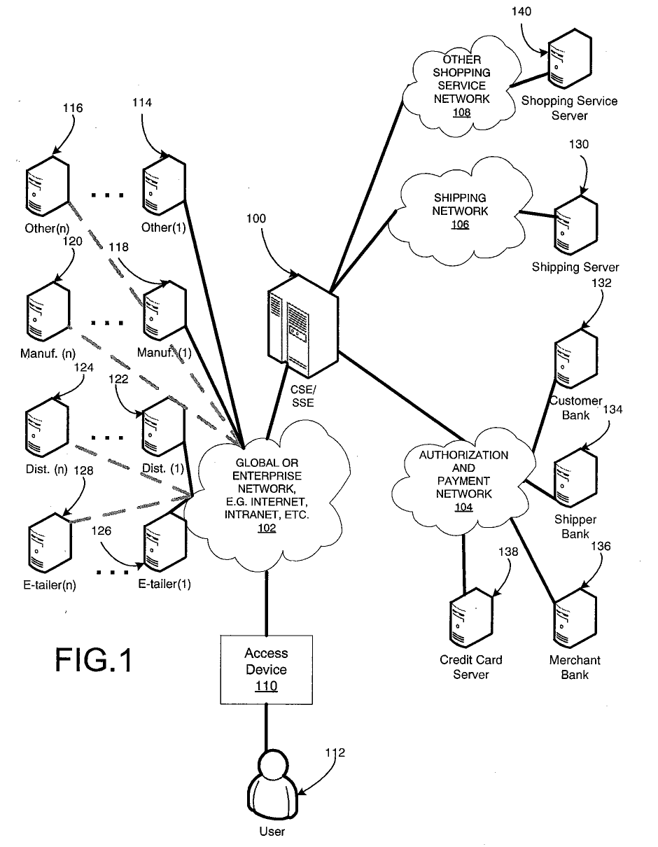

FIG. 1 illustrates an online shopping environment with a CSE/SSE 100 at the center and connected to a public or private network 102, payment and authorization network 104, shipping network 106 and any other miscellaneous shopping service network 108. These networks are interconnected via any means, such as open Internet Protocol and Transmission Control Protocol (TCP/IP) or proprietary means, such as Novell Netware™ protocol. The Internet provides file transfer, remote log in, electronic mail, news and other services. As described herein, the example public network of FIG. 1 is for descriptive purposes only. Although the description may refer to terms commonly used in describing particular public networks such as the Internet, the description and concepts equally apply to other public and private computer networks, including systems having architectures dissimilar to that shown in FIG. 1. For example and without limitation thereto, the system of an example embodiment can find application in public as well as private networks, such as a closed university network, or the private network of a company.

Public networks are generally not secure in nature although methods for adding security to the connections in public networks exist. Private networks are inherently secure by the nature of their design and authorization, payment and shipping networks tend to be private networks due to their stringent security requirements. As described earlier, these networks may operate over a public network provided adequate security measures are in place.

Each server-to-server, e.g. E-tailer(1) 126 to CSE/SSE 100 and client-to-server, e.g. User 112 to CSE/SSE 100 communication as described in at least one embodiment of the presented system can be unsecured or secure. Unsecured connections if used at all should be limited to communicating and exchanging public and non-confidential information and contents, such as search results viewing, simple product navigation and the like. Secure connections are used for communicating and exchanging all personal, confidential and proprietary information and contents whether it is over a public network or private. Such communication include, but not limited to, security registration with sellers and authorization brokering service providers, payment requests, purchase order dispatches, shipping order dispatches, etc.

Connected to network 102, a plurality of E-tailer(1) 126 through to Etailer(n) 128; a plurality of distributor web sites Dist.(1) 122 through to Dist.(n) 124; a plurality of manufacturer's web sites Manuf.(1) 118 through to Manuf.(n) 120; a plurality of interesting web sites Other(1) 114 through to Other(n) 116, where 1≦n. A user 112 (who is also a customer in context of shopping) accesses web sites via network 102 through an access device 110. Access device 110 may suitably comprise any computing device capable of accessing network 102. Customers, E-tailers, distributors, manufacturers and interesting web sites operate and communicate over 102 with CSE/SSE 100.

E-tailers 126, 128 provide retail product information to SSE 100. Retail product information includes the identity (make and model), retail price the merchant is charging for the products, applicable sales tax, shipping costs, any discount information and the like. Distributors 122, 124 provide intermediary product information to the SSE. Intermediary product information includes the identity (make and model, if available), availability, logistic information and the like. Manufacturers 118, 120 provide detail features, specifications, MSRP, release, recall, safety information and the like for a product. Interesting sites 114, 116 provide derived and logical product information, such as product reviews, news, press releases, consumer affairs, standards, compliance, conformance, brand, product's industry-specific information and the like. Examples of such sites include Powerreviews.com and Thisnext.com. A user 112 or a plurality of users provide user-generated product information, such as product images, videos, reviews, recommendations, comments, ratings, surveys, jokes and the like.

SSE 100 may receive retail, intermediary, detail, derived or logical product information in at least one of the following means:
1. By SSE 100 crawling web site of the source of information,
2. By source of information entering data into SSE 100 manually,
3. By source of information entering data into SSE 100 by programmatic means using API and/or protocols

It may be possible to receive such data by other means. Manufacturer, distributor and interesting site sourced product information is aggregated into a single entry of the product database while each product entry contains a list of E-tailer provided product information and their offerings. User-generated product information is generally entered using means 2 and/or 3 above and such information may be moderated and appropriated prior to associating them with the product in question within SSE 100. Further, the system may indicate user-generated contents when displaying product information such that is visible to other users. This allows a user to understand the appropriate credibility and authenticity of different pieces of information about a product.

Payment and authorization network 104 connects various banks and credit card servers. At least one customer bank 132; at least one shipper bank 134; at least one merchant bank 136 and at least one credit card server 138 communicate with one another over the network 104. In an example embodiment, Network 104 is secured with various means such as IP Security (IPSec), Virtual Private Network (VPN), Transport Layer Security (TLS) and Secure Socket Layer (SSL) operating either over public Internet or private enterprise or financial networks. For describing the presented system, a simplified model of how customer-to-merchant monetary transaction takes place is described. In this model, a customer bank 132 issues credit and/or debit cards to its customers and negotiate with shipper's bank 134 and merchant's bank 136 for allowing its customers to be able to send payments for goods and services received from shippers or merchants. Shipper bank 134 manages and operates merchant accounts for shippers and merchant bank 136 manages and operates merchant accounts for merchants allowing them to receive payments for goods and services they provide to various customers. Each customer bank registers its issued credit and/or debit cards with payment authorizers, such as VISA™ or MASTERCARD™. Each of shipper and merchant bank register their merchant accounts with the payment authorizers. Payment authorizers, who operate at least one credit card server 138, provide the means for validating and authorizing payment requested by a customer to be remitted to a merchant and/or shipper she purchases a service from. This allows an authorized transaction to take place instantly and guarantees the payment for a merchant from a customer. It is necessary for the sender of a payment, i.e. a customer to send a payment through an authorizer that the recipient merchant is registered with and supports in order for the transaction to succeed.

CSE 100 communicates with credit card server 138 in order to send proxy payment requests on behalf of a user for a merchant when a product or service is purchased through CSE 100, by the customer, from the merchant. A proxy payment request may also be sent by CSE 100 for a shipper for providing shipping services to a customer. Appropriate security provisions and registrations are implemented by at least one embodiment of the presented system in order to maintain customer and merchant confidential financial and personal information protected and prevent unauthorized access to such information.

Shipping network 106 operates either over public Internet or private enterprise network and connects CSE 100 with shipping service providers who operate at least one shipping server 130. Shipping service providers provide various shipping services, such as carrying a purchased item from merchant to the customer who bought the item. Shipping servers provide means for receiving shipping information, such as shipment identifier, source address, destination address, type of service, delivery instructions, payment information and the like and dispatching them to the appropriate physical pickup station. Typically, physical pickup stations are close to the merchant warehouse or physical location of a shippable item in order to conveniently pick up the item.

Other shopping service network 108 operates either over public Internet or private enterprise network and connects CSE 100 with miscellaneous shopping service providers who operate at least one shopping server 140. These shopping servers may provide services such as shipping insurance that may protect a customer from any damage that might occur while an item is in transit from the merchant en route to the customer by means provided by a shipping service provider.

In operation, user 112 inputs into access device 110 data representative of an item the user is interested in. Access device 110 forwards the data to CSE/SSE 100 over network 102. SSE 100 crawls and collects this item and other data from E-tailers 126, 128; distributors 122, 124; manufacturers 118, 120; and other interesting sites 114, 116 and stores for serving requests for the item. If the item is found locally by SSE 100, it is returned to access device 110 via network 102. If the item is not found locally by SSE 100, it may query and collect information on the item from at least one E-tailer or distributor or manufacturer or other interesting sites.

User 112 browses through the information provided, one of which is a list of E-tailers 126, 128 offering the item. If she chooses to purchase the item from a particular E-tailer 126 through CSE 100, she inputs into access device 110 data representative of a payment method provided by customer bank 132 and accepted by merchant bank 136 who provides merchant services to E-tailer 126. Access device 110 forwards the data to CSE/SSE 100 over network 102. CSE 100 communicates with credit card server 138 over network 104 for payment authorization on behalf of user 110 for E-tailer 126. Credit card server 138 provides instant authorization for payment and communicates authorization result back to CSE 100 over network 104. Credit card server 138 may communicate with merchant bank 136 and customer bank 132 over network 104 for certain payment methods, such as a debit card or an electronic check. Upon a successful payment authorization, CSE 100 sends a purchase request to E-tailer 126 over network 102.

User 112 inputs into access device 110 data representative of a shipment method provided by shipping server 130, who receives payment services for shipment from shipper bank 134. Access device 110 forwards the data to CSE/SSE 100 over network 102. CSE 100 communicates with credit card server 138 over network 104 for payment authorization on behalf of user 110 for shipping server 130. Credit card server 138 provides instant authorization for payment and communicates authorization result back to CSE 100 over network 104. Credit card server 138 may communicate with shipper bank 134 and customer bank 132 over network 104 for certain payment methods, such as a debit card or an electronic check. Upon a successful payment authorization, CSE 100 sends a shipment request to shipping server 130 over network 106. User 112 receives the purchase, payment and shipment confirmation from CSE 100 over network 102 and access device 110. CSE 100 may communicate with various shopping service providers, such as insurance and warranty and operate a shopping service server 140 over network 108.

### General System Architecture.

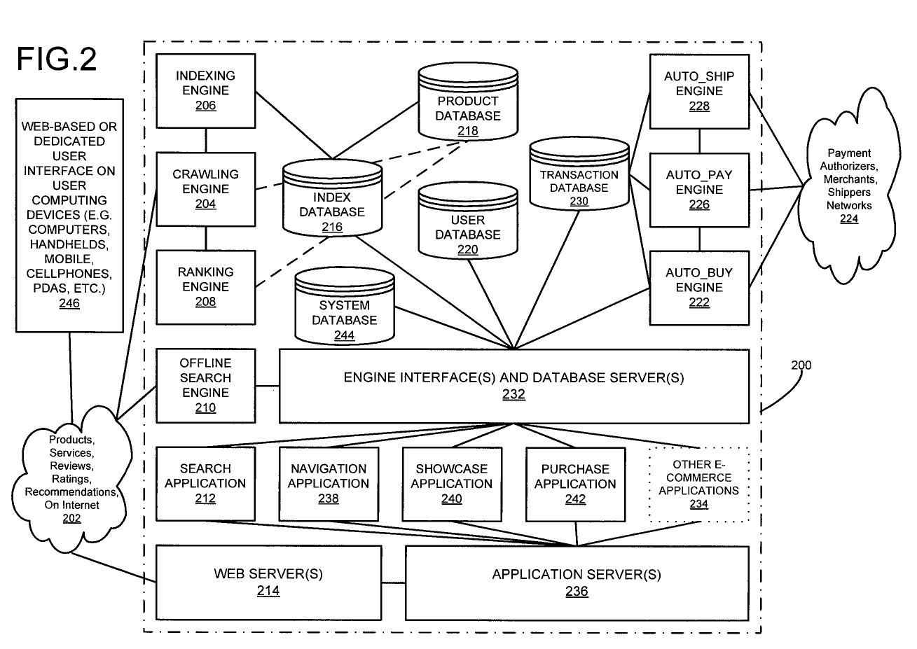

FIG. 2 illustrates the general architecture of a CSE/SSE 200 that operates in accordance with at least one aspect of the presented system. For example, CSE/SSE 200 suitable to implement the functionality of CSE/SSE 100 illustrated in FIG. 1. As shown in FIG. 2, a plurality of graphical user interface (GUI) displays is presented on a plurality of user interface devices 246 connected to an apparatus 200 via Internet 202. The user interface may be any device capable of presenting data, including, but not limited to, cellular telephones, television sets or hand-held “personal digital assistants”.

Apparatus 200 can be connected to Internet 202 through a router and a switch. The router forwards information packets between apparatus 200 and user devices 246 over Internet 202. In one example embodiment, apparatus 200 may also include a load balancer (not shown) that balances the traffic load across multiple mirrored servers and a firewall (not shown) provides protection from unauthorized access to the apparatus. The switch may act as a gatekeeper to and from the Internet. The components appearing in the apparatus refer to an exemplary combination of those components that would need to be assembled to create the infrastructure in order to provide the tools and services contemplated by the presented invention. As will be apparent to one skilled in the relevant art(s), all of components “inside” of the apparatus may be connected and may communicate via a wide or local area network (WAN or LAN).

Apparatus 200 comprises a web server 214 or plurality of web servers 214. The web server is a system that sends out Web pages in response to HTTP requests from remote browser applications that operate on user devices (i.e. users of access device 246). That is, web server 214 provides the GUI to users of the devices 246 in the form of Web pages. These Web pages sent to the user's device 246 would result in GUI screens described earlier being displayed. Web server 214 may be adapted to serve different web pages to different clients. For example, whereas web server 214 may send search results and product showcase pages to user access device 110; web server 214 may send E-tailer interface pages to E-tailers 126, 128; web server 214 may send distributor interface pages to distributors 122, 124; web server 214 may send manufacturer interface pages to manufacturers 118, 120. E-tailer, distributor, manufacturer and user interface pages may include provisions for each to submit product information pertaining to their realm of expertise to the SSE. The web pages served to particular clients may be determined by user ID and passwords entered in an initial login page served to all clients accessing the SSE, or by some other access control mechanism. User names, passwords, and the like may be stored in a user database 220 associated with apparatus 200.

Apparatus 200 comprises an application server 236, which serves as the application layer of the present system. Application servers 236 may include non-shopping service applications, such as an image application, which has the purpose of storing and providing digital images to other components of the apparatus; a mail application, which sends and receives electronic messages to and from user devices 246; and a media application, which has the purpose of storing and providing digital media and video to other components of the apparatus 200.

Application server 236 comprises several applications that are described by embodiments of the presented system. Search application 212 receives and processes various types search requests from a user device 246 through Internet 202 and web server 214, communicates with back-end engine interfaces and database servers 232; receives search results from 232 and sends the results Web pages to user device 246 through web server 214 and Internet 202. Navigation application 238 receives and processes various types of shopping browse requests from a user device 246 through Internet 202 and web server 214, communicates with back-end engine interfaces and database servers 232, receives navigation objects from 232 and sends the objects Web pages to user device 246 through web server 214 and Internet 202. Showcase application 240 receives and processes a product or service show requests from a user device 246 through Internet 202 and web server 214, communicates with back-end engine interfaces and database servers 232, receives product showcase in detailed or brief format from 232 and sends the showcase Web pages back to user device 246 through web server 214 and Internet 202. Purchase application 242 receives and processes various types of purchasing requests from a user device 246 through Internet 202 and web server 214, communicates with back-end engine interfaces and database servers 232, receives purchasing responses from 232 and sends the responses Web pages to user device 246 through web server 214 and Internet 202. It is desirable to add future e-commerce application 234 to apparatus 200 that are relevant to a CSE/SSE, such a selling or auctioning or discounting application. One example embodiment may integrate an e-commerce application into apparatus 200 in a similar structure as a search application 212 or a navigation application 238 or a showcase application 240 or a purchase application 242. Another example embodiment may integrate an e-commerce application into apparatus 200 using a different structure than the illustrated applications.

Apparatus 200 comprises an engine interface and database server 232 or a plurality of engine interfaces and database servers 232. The engine interface serves as the background task layer to the application layer of the present system. Search application 212, navigation application 238, showcase application 240, purchase application 242 and any other e-commerce application 234 communicate with index database 216, product database 218, user database 220, transaction database 230 and system database 244 via database server 232. These applications communicate with offline search engine 210, auto_buy engine 222, auto_pay engine 226 and auto_ship engine 228 via engine interface 232.

Apparatus 200 comprises a crawling engine 204, an indexing engine 206, a ranking engine 208 and an offline search engine 210—collectively serving the back-end SSE functionalities. Crawling engine 204 crawls the Web sites of partnering entities with SSE 200, which may include E-tailers, manufacturers, distributors, interesting and content aggregation sites on Internet 202 and fetches relevant product information. Such information may be parsed for populating product database 218 manually or using a computer program. Indexing engine 206 indexes all databases in apparatus 200 and builds a set of indexes for high-performance and highly-scalable shopping search. Ranking engine 208 parses ranking parameters and relevant tables in product database 218 and calculates ranking of products or services in each leaf category. Offline search engine 210 periodically searches the WWW for search terms and parameters desired by a user.

Apparatus 200 includes an index database 216, product database 218, user database 220, transaction database 230 and a system database 244. Index database 216 stores optimized indexes of data stored in all databases in apparatus 200. Product database 218 stores products, services, manufacturers, brands, industry standards, consumer affairs and any other data item related to shopping. One example embodiment of the product database may contain a set of categories, objects and object attributes. User database 220 stores data items related to customers, E-tailers, partners, distributors and any other user of apparatus 200. Transaction database 230 stores payment, shipment, purchase and any other data item related to transactions that take place through apparatus 200. System database 244 stores software, digital images, digital media, system data and any other data item required by the other components of the apparatus. The databases may be provided, for example, as a database management system (DBMS), and object-oriented database management system (ODBMS), a relational database management system (e.g. DB2, ACCESS etc.), a file system or another conventional database package. Thus, the databases can be implemented using object-oriented technologies or via text files. Further, the databases can be accessed via a Structured Query Language (SQL) or other tools known to one of ordinary skill in the art.

Apparatus 200 comprises an auto_buy engine 222, an auto_pay engine 226 and an auto_ship engine 228—collectively serving the back-end commerce functionalities. Auto_buy engine 222 receives an automated purchase request from purchase application 242 via engine interface 232 and invokes itself, auto_pay engine 226 and auto_ship engine 228 for completing payment, shipment and order placement with appropriate external servers through network 224 or a plurality of networks 224. Auto_pay engine 226 sets up secure payment tunnels with merchants and payment authorizers and relays payment information to the appropriate parties for completing payment for a purchase or a shipment. Auto_ship engine 228 sets up secure shipment tunnels with shippers and then relays shipment information to the shipper and relays shipment notifications to the corresponding merchants for completing shipment for a purchase. Auto_buy engine 222, auto_pay engine 226 and auto_ship engine 228 store transactional data items in transaction database 230.

Apparatus 200 also comprises a second switch that allows the components of the apparatus to be interconnected in a local area network (LAN) or a wide area network (WAN). Thus, data can be transferred to and from the various components of apparatus 200. As will be appreciated by those skilled in the relevant art(s), this configuration of router and switch is flexible and can be omitted in certain embodiments. Additional routers and/or switches can also be added.

The servers included in apparatus 200 are shielded from public Internet 202 through a firewall, which is a dedicated gateway machine with special security precaution software. It is typically used, for example, to service Internet 202 connections and dial-in lines and protects the cluster of more loosely administered network elements hidden behind it from external invasion. As will be appreciated by those skilled in the relevant art(s), the inclusion of the firewall is flexible and can be omitted in certain embodiments. Additional firewalls can also be added.

Any server included in apparatus 200 may include a central processing unit (CPU), a random access memory (RAM) temporary storage of information, and a read only memory (ROM) for permanent storage of information. A server may be generally controlled and coordinated by operating system software. The operating system controls allocation of system resources and performs tasks such as processing, scheduling, memory management, networking and I/O services, among things. Thus, the operating system resident in system memory and executed by CPU coordinates the operation of the other elements of the apparatus.

Although the description of the server may refer to terms commonly used in describing particular computer servers, the description and concepts equally apply to other processing systems, including systems having architectures dissimilar to that shown in FIG. 2.

Also included is an inter-process communications protocol (IPCP), a set of rules for marshalling and un-marshalling parameters and results. This is the activity that takes place at the point where the control path in the calling and called process enters or leaves the IPCP domain. The IPCP is essentially a set of rules for encoding and decoding information transmitted between multiple processes. IPCP methods include technologies, such as Remote Procedural Call (RPC), External Data Representation (XDR), etc.

As will be appreciated by those skilled in the relevant art(s), the inclusion of the IPCP is flexible and can be substituted or omitted in certain embodiments.

### Shopping Navigation.

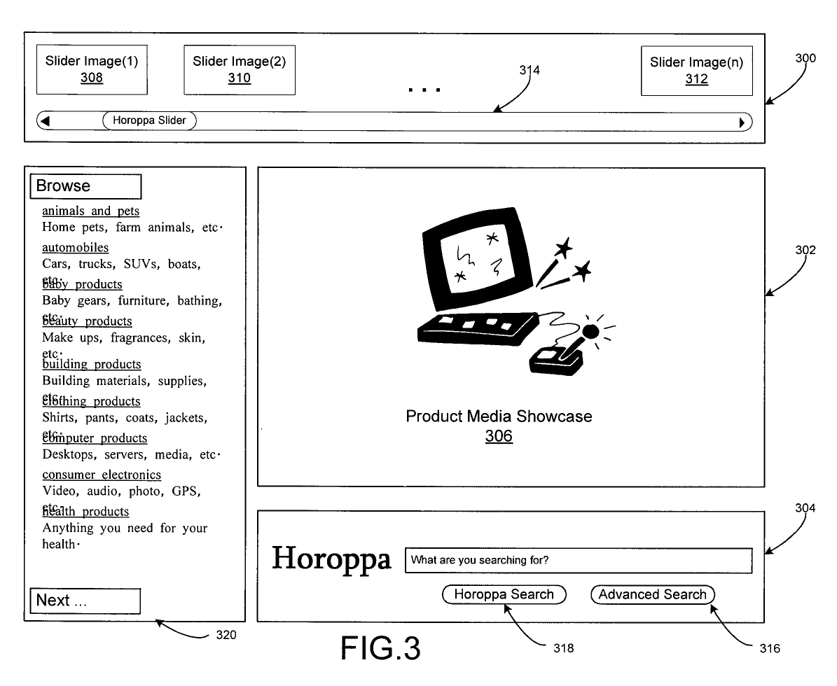

FIG. 3 illustrates an example shopping navigation page that demonstrates a Web page displayed to a user 112 by access device 110 connected to CSE 100 over a network. CSE 100 operates in accordance to at least one aspect of the presented system. Among the features of the CSE are the manner in which product categories are presented on the shopping navigation pages and the competitive manner in which E-tailers, distributors and manufacturers negotiate advertisement fees in exchange for prominent placement on the shopping navigation pages. An aspect of these features is a personalized method of charging for advertising. According to an aspect of the system, an E-tailer 126 may pay a fee to have its name, a single or multiple product offerings prominently displayed within the product media window 302 or any other prominent advertisement area contained in the shopping navigation pages served to users according to their shopping interests, preferences, favorites, wish lists, watch lists, recommendations, reviews and the like containing specific words, phrases, products, or the like in these. Similar to E-tailers, a distributor 122 may pay a fee to have its name and distributed product offerings prominently displayed as a media showcase 306 within product media window 302 and a manufacturer 118 may pay a fee to have its name and a new product release showcase within product media window 302. Media window 302 is capable of displaying graphical, imagery, animations, rich media, video, text, high-definition video, etc.

The advertisement fees negotiated with E-tailers, distributors, manufacturers or any other offerers are facilitated further by a hierarchical means for separating out different industries and product categories. A root shopping navigation page displays different industries, such as Travel, Food, Communication, Media, Electronics and others, each with one line summary within a browse window 320. For easier navigation, a slider window 300 is also presented on the root shopping navigation page containing representative images for each industry—slider image(1) 308, slider image(2) 310 through to slider image(n) 312, where 2≦n. For example, slider image(1) 308 may be a computer icon representing the computer industry and slider image(2) may be a hamburger clip art representing the food industry. As there may be more images representing the number of industries from which products are stored by an example embodiment of the presented system than slider window 300 can display on a user's browser display area. A slider 314 allows scrolling to other industry images contained within slider window 300. Each industry is represented using hyper-link titles, such as “Animals and Pets,” “Automobiles,” “Clothing and Apparels” and others along with a one-line summary of the constituents of the industry within browse window 320.

When a hyper-link title in browse window 320 or an industry representative image 308, 310 or 312 is clicked, the system descends into that industry, re-displays browse window 320 with its sub-industry hyper-links and one-line summaries for each of its sub-industry and re-displays slider window 300 with the representative images for each of its sub-industry. For example, if a user clicks on “Automobiles,” browse window 320 re-displays with “Cars,” “Vans,” “Trucks,” “Boats” and other sub industries or categories within automobiles. Slider window 300 re-displays with clip arts or icons or other graphical images for cars, vans, boats and other sub industries or categories within automobiles. Clicking on “Cars” or the slider image representing a car, causes the system to further descend into car leaf categories, i.e. the categories that cannot be further descended into, re-display the slider window 300 with clip arts or icons or other graphical images of sedans, sport cars, hatchbacks, convertibles and other sub-categories of cars and re-display browse window 320 with “Sedans,” “Hatchbacks,” “Sport Cars” and titles for other sub-categories of cars along with their one-line summaries.

Browse window 320 provides users the ability to navigate and browse through different industries and product categories, and this method is used by a majority of search engines and comparison shopping sites. Using a slider window 300 based shopping navigation has several advantages for both users and offerers alike. For example, at each navigation page, product media window 302 and/or any other prominent advertisement area can display offerer advertisements starting with the highest fee payer within the industry, sub-industry or product category and then the next highest fee payer and so on until a given shopping navigation page is continued to be viewed by a user according to a list of advertisement materials prepared by matching with her interests, preferences, favorites, wish lists, watch lists, recommendations, reviews and the like containing specific words, phrases, products, or the like in them. Further, each time user 112 hovers a mouse or a similar or different pointing device over a slider image 308, 310 or 312 using a user device 110, the list of advertisement materials for the industry, sub-industry or product category of the representative image is used for selecting and displaying the advertisement materials in product media window 302 and/or any other prominent advertisement display area. In case of mouse over, the advertisement material may persist for a certain time until the next advertisement material is displayed. In both forms of advertisements, i.e. within the same industry, sub-industry or product category or descended into a child sub-industry or product category using mouse hovered over a slider image 308, 310 or 312, higher fee payers may be given longer durations of display times for their advertisements in a descending order.

Similar methods to the slider window and image controlled, personalized and timed advertisements can be used in other Web sites, such as a real-estate site, descending down from the world, to the United States, to one of the fifty states, to a specific city, to a specific suburb, each time displaying real-estate agent and broker advertisements at the international, national, state, city and suburban navigation pages. Personalization can be provided based on a user who is also real-estate investor or potential buyer's property watch list and the like.

The shopping navigation pages further contain a search window 304 containing a search form with a basic search button 318 and an advanced search button 316. Basic search and advanced search features are described as at least one aspect of the presented system. One important difference of both of these types of search with the basic and advanced search described in other parts of this invention is that the SSE searches only within the industry, sub-industry and product category where the shopping navigation page is currently navigating.

### User Online Shopping Methods.

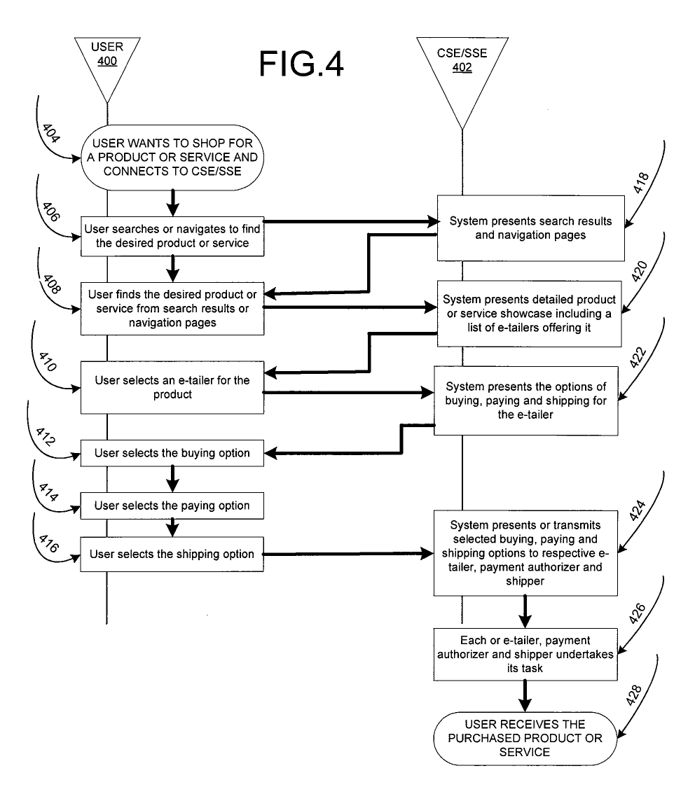

Reference is now made to FIG. 4, which is a simplified flowchart illustration of an example method of shopping where a user 400 and CSE/SSE 402 participate in accordance with one embodiment of the presented system. User 400 is registered with CSE/SSE 402 with personal, shopping, payment, shipment information and credentials, such as home address, phone number, email address, credit card details, preferred shipper and the like. For security and confidentiality of user 400, CSE/SSE 402 may employ appropriate security measures. For example, authentication methods can be incorporated into user login process based on passwords, challenges, biometrics or any other authentication method before any user's confidential information, such as credit card details are displayed to the user. User 402 confidential data may be stored in user database in encrypted form and only user 402 is able to allow the decryption of such data.

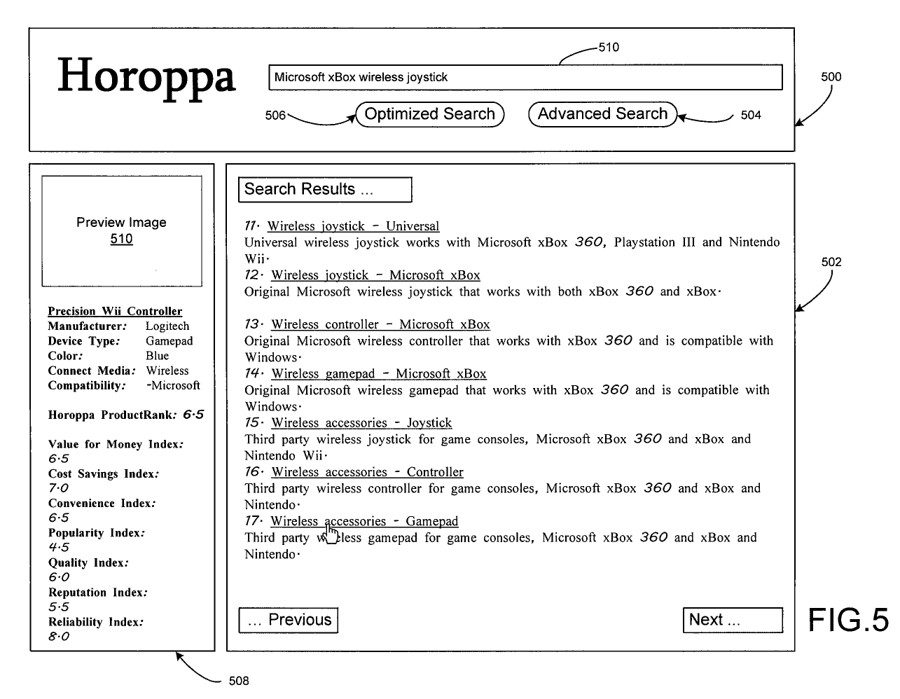

At 404, user 402 wants to shop for a product or service and visits CSE/SSE 402 Web site as described above in the description of FIG. 2. At 406, a shopping search or navigation is initiated using a search page or navigation page described above in the description of FIG. 3. At 418, CSE/SSE 402 provides appropriate search results and navigation pages for the product or service desired by user 400. The search results and navigation pages may contain plurality of different versions of the product or service originally searched or navigated by user 400. Among the features of CSE/SSE is the customized set of information presented for each different variation of the product or service sought by user 400. The customized information may contain several dimensions of a product or service described as part of the description of FIG. 5 below. This information are presented so that the user is able to compare different variations, brands, makes, models, etc. of a product or service, providing a means for product or service comparison, unlike what price comparison sites currently provide. CSE/SSE 402 may present means for tabulating and graphing different variations of a product or service against different dimensions in order to understand their relative merits and demerits.[stuff about product network] At 408, user 400 compares and chooses a particular variation of the product or service for purchase using comparison, tabulation, graphical and other means provided by one example embodiment of the presented system. At 420, CSE 402 presents the chosen product or service's showcase page, which includes in depth information aggregated from manufacturer(s), distributor(s), E-tailer(s), interesting third-party Web sites and past and current users who may have experience with the particular product or service chosen by the user. The showcase eliminates the need for each E-tailer to manage and maintain information about a particular variation of product, thus avoiding duplicate and redundant information presented to user 400. The showcase page also contains a list of E-tailers actively e-tailing the product or service along with their service offerings, such as price, discount, shipping, warranty and the like information.

At 410, user 400 chooses an E-tailer to purchase the desired product or service. At 422, CSE 402 presents the user with options of manual purchase or automated purchase. Among the features of CSE, are the methods for making automated purchase of a product including automated payment and automated shipment based on user 400 payment and shipment credentials, pre-saved or provided at the time of purchase, through the CSE. Manual purchase, on the other hand, is a method in which the user must visit the chosen E-tailer site, provide payment and shipment information in order to complete the purchase. Each of purchase, payment and shipment option can chosen to be manual or automated separately, providing the user flexible methods for completing a purchase. At 412, user 400 selects the purchase option; at 414, user 400 selects the payment option and at 416, user 400 selects the shipment option. At 424, CSE 402 presents the appropriate Web pages for the methods chosen. For example, an automated purchase may require user 400 entering payment as well as shipment credentials so that proxy payment and shipment can be completed by CSE 402 on behalf of user 400. An automated payment and manual shipment may require user 400 entering payment credentials so that proxy payment can be completed by CSE 402 on behalf of user 400 and then direct the user to the E-tailer or a shipper site so that the user can manually complete the shipment for the purchase. At 426, CSE 402 as well as external E-tailer and/or shipper completes the tasks needed in order to complete the purchase and ship the product or service to user 400. At 428, the user receives the purchased product or service.

The product comparison, showcasing and E-tailer listings along with automated purchasing, paying and shipping methods described herein provide additional enhancements to online shopping. The order in which the steps of the online shopping model described herein may vary. For example, if a user chooses to physically pick up a purchased product, the ship step may not be presented by the one example embodiment of the presented system, whether the method is manual or automated. It is also possible that after receiving a product, the user returns it. However, unlike the price comparison and manual purchasing methods, whereby a separate purchase must be made from each E-tailer and employed by other comparison shopping engines, users can compare products, E-tailers offering those products; then purchase, pay and instruct shipping of the purchase in the present model, all from a single site, as desired. The automated purchase, payment and shipment methods provide significant advantages for both merchants and customers alike, particularly when multiple items are purchased by a customer from different merchants.

### Shopping Search and Search Results.

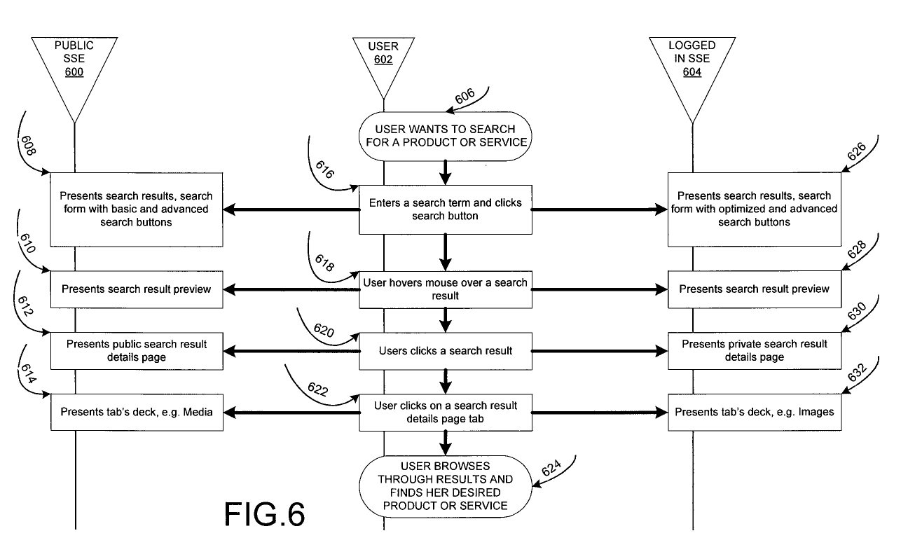

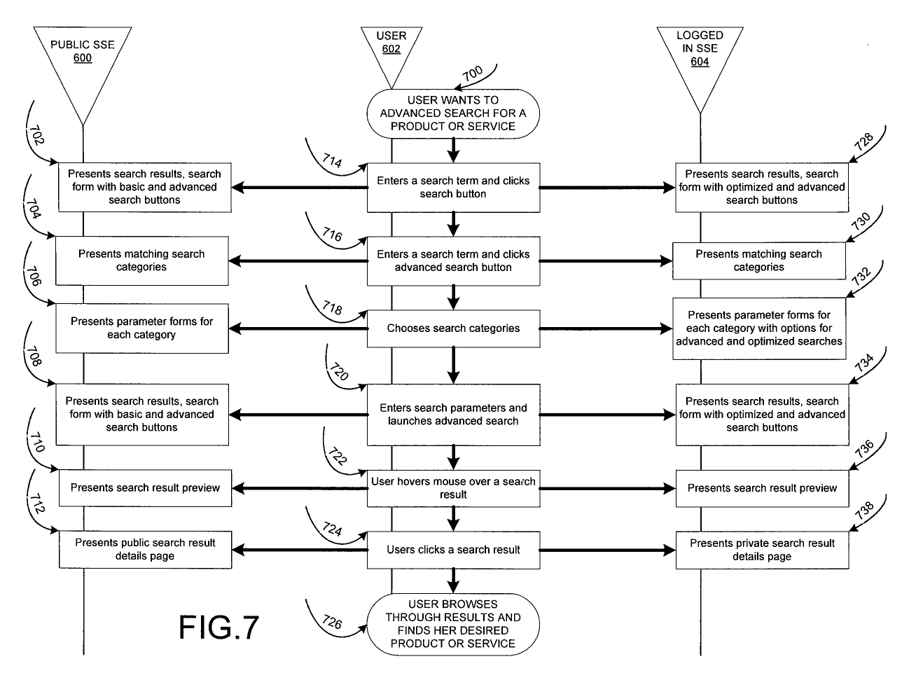

FIG. 5 illustrates an example of a search results page that demonstrates a Web page displayed to a user 112 by access device 110 connected to SSE 100 over a network. The SSE operates in accordance to at least one aspect of the presented system. When a user is logged in, the search results page contains a search window 500 with a search text-box 510, an optimized search button 506 and an advanced search button 504. While the methods of optimized and advanced search are described below in descriptions of FIG. 6 and FIG. 7, the search window 500 exemplifies a simple launch point for shopping search.

Also contained in a search results page, a search results window 502 lists the results for any kind of search requested by a user, such as basic, advanced or optimized. In an example embodiment, search results are presented in a strict order of ranking and only a limited, top-ranking, high-quality results are presented, unlike other search engines and comparison shopping engines who present exhaustive list of results although a user seldom traverses beyond a few hundred search results. For example, a search on a first well-known search engine for “Barbie doll” produced 1,610,000 results and the same search on a second well known search engine produced 55,445 results. It is known that browsing through search results is a daunting and time-consuming task for users and it is generally expected that the desired results should appear within the results presented at the initial search result pages. A SSE operating according to the presented system generates and derives high quality search results using its internal ranking functions as well as blend those with user ranking parameters specified at the time of search or through a shopping profile in terms of ranking factors. For example, if a user indicates in her shopping profile that ‘reliability’ and ‘aesthetics’ are the two most important ranking factors, the ranking function first generates it set of ‘N’ number of results according to its internal calculations and then re-ranks them according to the ‘reliability’ and ‘aesthetics’ attributes of the results, discards the low-ranking results and selects the ‘M’ number of higher-ranking results for presenting to the user, where M≦N. One example embodiment of the system may allow users to specify different ranking factors for different industries, sub-industries and product types. For example, for toys, ‘safety’ may be specified as most important factor to one user; while ‘color’ and ‘reliability’ may be specified as the most important factors for ‘sedan’ cars to the same or a different user; while ‘performance’ and ‘price’ may be specified as the most important factors for ‘sport cars’ to the same or a different user. The results presented are always numbered according to their ranks for the search performed. If a user cannot find the desired result within the M number of results presented, the SSE offers an alternative search method to the one performed, such as advanced or offline.

Also contained in a search results page is a search preview window 508, which allows users to be able to take a sneak peek at a search result prior to clicking the result and viewing the details of the result. As a result entry may be an internal Web page to the SSE or external, the preview window 508 allows a user to obtain some essential information about the result in order to decide whether viewing the details is necessary. The preview can be launched when a mouse or another pointing device hovers over the result entry, or by a different click than the one directing to the details page, or by any other user input device, such as a keyboard and its certain key combinations. The preview method can be particularly useful for shopping although the method can be used in general Internet search as well. Some of the key data about a product is embedded into the preview window 508. The data includes a title, an image 510, some key features and the like. More importantly, it includes some of the ranking parameters used by the SSE, the aggregate of which is presented in the form of product rank, which is a score between 0 and X, where X>0. The factors contributing towards this rank may be general, industry-specific, sub-industry-specific or product-category-specific and these are all quantified in terms of indexes between 0 and X. Some of the example factors include:
1. Value for money
2. Cost savings
3. Convenience
4. Popularity
5. Quality
6. Reputation
7. Reliability
8. Brand
9. Safety
10. Aesthetics

One aspect of product rank, and the factors contributing towards it, is that all factors are calculated using mathematical formulas and some of the calculations take into account quantities converted from qualitative data collected from user inputs, such as reviews, ratings, feedback, recommendations, wish lists and the like. “Value for Money”, which is one of the ranking factors may be calculated using the average current prices of all product variations of a product divided by the average current price of all products within the product-category. If the result is >1, the product is given a “Value for Money” index of 0. If the result is <1, 1—the value is multiplied by a normalization-factor Y, where Y>0, in order to derive the index of “Value for Money” for the product. For example, if a product is average priced by all its E-tailers at $100 while all products within the product category has an average price of $150, using Y=10, this product has a “Value for Money” index of 3.3. If another product within the same category is average priced at $180, has a “Value for Money” index for 0. If the product category was a digital camera and the first product would offer a better value for the money spent compared for the second product. However, the second product is likely to have a better quality index for its price. Popularity is one index that takes direct user input, such as search, browse, review and recommendation. An example formula for calculating the “Popularity” index may be-

Y*( (Number of searches for the Product/Total searches for all Products within the product category)+(Number of browses for the Product/Total browses for all Products within the product category)+(Number of positive reviews for the Product/Total positive reviews for all Products within the product category)+(Number of recommendations for the Product/Total recommendations for all Products within the product category)−(Number of negative reviews for the Product/Total negative reviews for all Products within the product category))

Clearly, product rank calculated using manufacturer, distributor, E-tailer, interesting and third party sites and user inputs is advantageous for all of customers, manufacturers, distributors and manufacturers. It encourages manufacturers to produce products in order to score better ranks in product's physical attributes, such as quality and reliability, in comparison with its competitors in a product category or industry. It encourages E-tailers to offer better price, delivery and other services to score better ranks in product's retail attributes, such as E-tailer rating and convenience. It allows users to be aware of their inputs that affect product ranking and differentiate objective and subjective reviews, recommendations and the like appropriately.

Reference is now made to FIG. 6, which is a simplified flowchart illustration of an example basic shopping search where a user 602 interacts with a SSE 600 that is serving general public and the same or different SSE 604 serving registered and logged in users. The SSE may serve a set of Web pages for general users and another set of Web pages for registered and logged in users. Logged in users usually have a HTTP session for the duration of their time actively spent on the SSE Web pages. One example embodiment of the presented system may choose to automatically disconnect a session that has been inactive for a certain period of time.

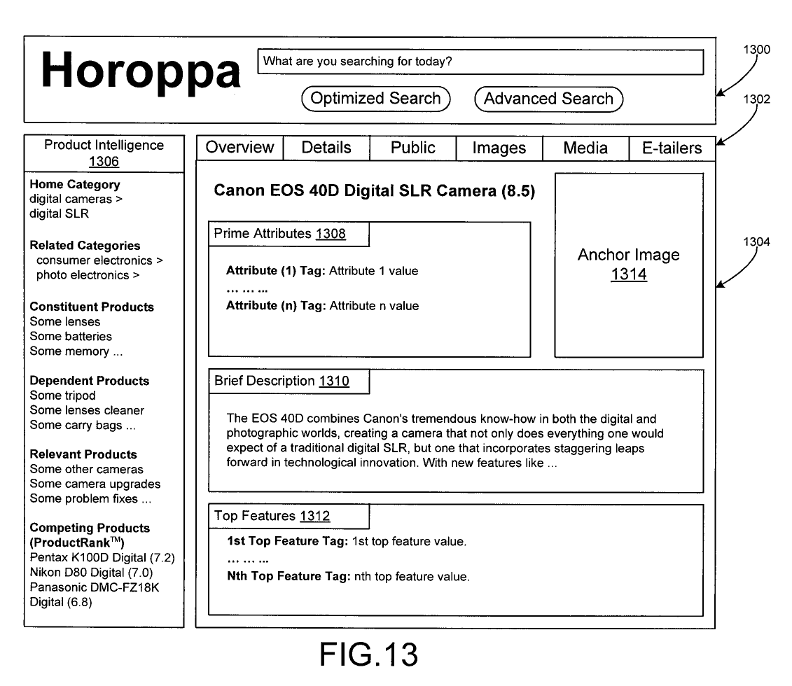

At 606, user 602 wants to search for a product or service. At 616, user 602 enters a search term into a search term box described as part of description of FIG. 5 above and clicks the search button. At 608, a public SSE presents the search results as a hyper-linked title and a one-line summary each and only the options for basic and advanced search while at 626, a logged in SSE presents the results as a hyper-linked title and a one-line summary each and the options for advanced and optimized search. At 618, the user moves a mouse or other pointing device on a search result. At 610, a public SSE presents a search result preview and at 628, a logged in SSE presents a search result preview. In an example embodiment, a difference between 610 and 628 is that a logged in user is presented with additional and personalized information search result preview. As described above, the preview window 508 is used for displaying the result preview information. At 620, the user clicks on a search result's title hyper-link. At 612, a public SSE presents the showcase display for the search result which contains the public information about the result while at 630, a logged in SSE presents the showcase display for the search result which contains all information about the result. The result showcase, which is likely to be a product, may initially display a showcase page similar to the one illustrated in FIG. 13. The public portion of a showcase contains general information about the result, such as product overview, some details, images, media contents and public forums, blogs, discussions, reviews and the like. A logged in user may be presented with additional information about products. For example, a shopper may be presented with price and discount histories, user generated images and media contents, private forums, groups, reviews and recommendations for a product. Similarly, an offerer may be presented with a product's competitiveness, performance, user generated images and media contents and the like.

In an example embodiment, a showcase is presented in the form of a tabbed interface widget. Presenting a showcase using a tabbed interface widget has several advantages, such as grouping different types of information about a product, presenting certain tabs to certain types of users and the like. One example embodiment of the presented system may use four tabs: 1) overview; 2) details; 3) shopper; and 4) offerer and present the overview tab to general public users; present overview, details and shopper tabs to shopper users and present overview, details and offerer tabs offerer users. At 622, the user clicks a tab available to according to the user type, i.e. public, shopper or offerer and at both 614 and 632, the desired tab is presented to the user. At 624, the user previews and browses through various search results until finding the desired product or service.

Reference is now made to FIG. 7, which is a simplified flowchart illustration of an example advanced shopping search where a user 602, interacts with a SSE 600 that is serving general public and the same or different SSE 604 serving registered and logged in users. At 700, user 602 wants to search for a product or service by specifying various search parameters. Similar to the search launch description as part of FIG. 6 description above, at 714, the user requests a basic search and at 702 and 728 search results are presented to the user according to the user type, i.e. public or logged in. Among the features of an example embodiment, are that the SSE presents all the industries, sub-industries and product categories that are likely to contain entries according to user's search term to the user so that at least one particular category can be selected for an advanced parameter-based search. Unlike other comparison engines that allow generic parameter, such as price, discount, color, weight or dimensions of a product, the SSE dynamically finds the searchable parameters for an industry, sub-industry or product category and allows a user to specify each of those parameters for search within a given industry, sub-industry and product category. The search parameters that are presented are similar to object-oriented programming class hierarchy. Those who are skilled in object-oriented programming would understand that all public objects and methods of a class are available to the children classes and then the grandchildren classes and so on - all those extending from the parent. In the case of advanced search parameters, each sub-industry allows searching based on its own searchable parameters as well as its parent industry's searchable parameters. Each product category allows searching based on its own searchable parameters as well as its parent sub-industry's searchable parameters as well as its grandparent industry's searchable parameters. This method of parameter-based search is advantageous to customers in finding their desired product quickly if they know the specific attributes of the product. Any parameter not specified is not considered by advanced search algorithm.

While dynamically sensing the categories based on a search term in order to search a database of products are extensible for searching any other objects in a database or similar datastore that are organized in a hierarchical manner. Similarly, allowing search parameters for the dynamically sensed categories is also beneficial in general Internet and object search.

At 716, user 602 may use the original search term used in basic search or enter a new search prior before clicking the advanced search button. At 704 and 730, SSE presents the list of categories where a parameter-based search can be launched. At 718, the user chooses at least one category within which the search is desired. At 706, the public SSE presents a form containing the searchable parameters for each category chosen. At 730, the logged in SSE presents a similar form as at 706; however, the searchable parameters may differ for the logged in user. For example, an example embodiment of the presented system may allow only a subset of all searchable parameters available for a given industry, sub-industry or product category to general public in order to provide incentive for them to register with the system and be able to perform advanced search based on a greater number of parameters for an industry, sub-industry or product category.

At 720, user 602 enters the search parameters and clicks the perform search button. At 708 and 734, search results are presented to the user according to the user type. Search result previewing illustrated at 722, 710 and 736; showcasing results illustrated at 724, 712 and 738 are similar to search result previewing and showcasing described as part of FIG. 6 description. At 726, user browses through various search results, previews and showcases in order to find her desired product.

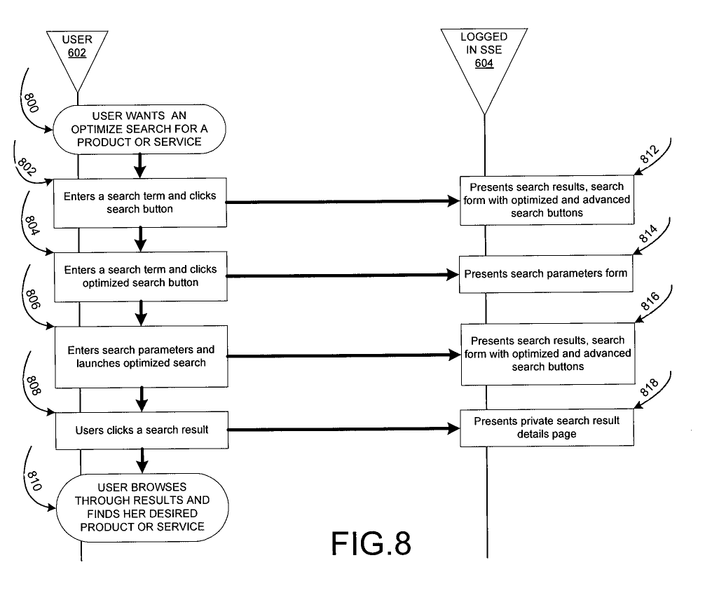

Reference is now made to FIG. 8, which is a simplified flowchart illustration of an example optimized shopping search where a logged in user 602, interacts with a SSE 604 servicing registered and logged in users as optimized search is suitably supported for logged in users although one example embodiment of the presented system may offer optimized search to public users. At 800, user 602 wants to search for a product or service based on abstract interests and preferences. Similar to the search launch description as part of FIG. 6 description above, at 802, the user requests a basic search and at 812 search results are presented to the logged in user. At 804, the user may use the original search term used in basic search or enter a new search prior before clicking the optimized search button. Among the features of an example embodiment, are that the SSE presents all the abstract parameters to rank and optimize the search results by; according to the industry, sub-industry and product-category where a particular search term may produce possible results. There may be generic optimization parameters, such as ‘popularity’ that may be used for searching within any category and specific optimization parameters, such as ‘reliability’ and ‘safety’ for searching within certain categories. Other example parameters are value for money, cost savings, convenience, reputation, brand, reviews, recommendations and the like. Allowing users to sort the search results based on abstract and derived optimization parameters, further based on user interests, preferences, future plans, past history and the like is desirable, particularly in shopping search while the method can be used in general Internet and object search in databases. As described earlier, the CSE product showcase incorporating the abstract and derived attributes for products as well as making those visible to the users allow users to understand the relation between the optimization parameter specification for search and their significance on product ranking and showcasing methods.

At 814, SSE 604 presents the user with the set of optimization parameters to choose from. At 806, user 602 selects the optimization parameters and clicks the launch search button. At 816, search results are presented to the logged in user. The search result browsing, previewing and showcasing illustrated at 808 and 818 are similar to those described as part of FIG. 6 description. At 810, user browses through various search results, previews and showcases in order to find her desired product.

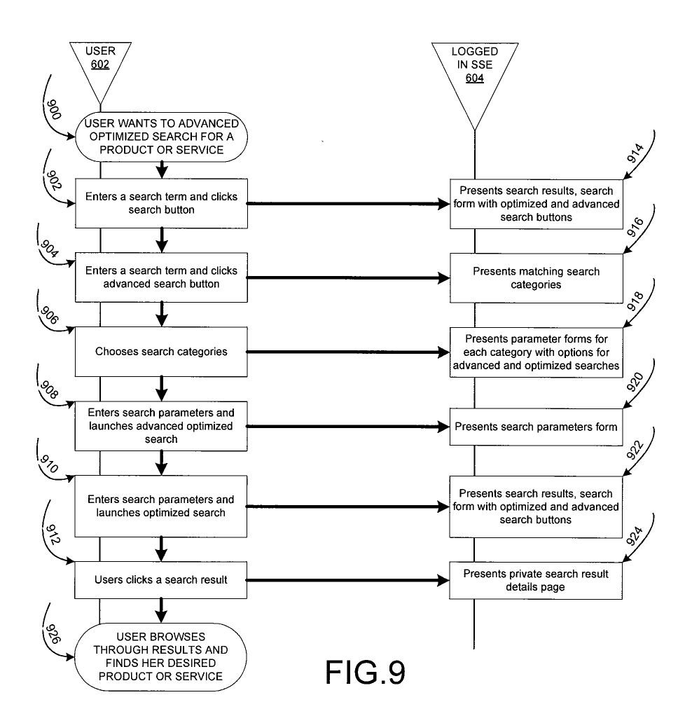

Reference is now made to FIG. 9, which is a simplified flowchart illustration of an example optimized advanced shopping search where a logged in user 602, interacts with a SSE 604 serving registered and logged in users as optimized advanced search is suitably supported for logged in users although one example embodiment of the presented system may offer optimized advanced search to public users. The method of optimized advanced is a combination of both advanced and optimized search whereby a user may choose to use searchable parameters for an industry, sub-industry and product-category for searching a product as well as specify abstract and derived parameters according to user interests, preferences, future plans, past history and the like. At 900, a user, such as user 602, wants to search for a product or service based on both advanced search and search optimization parameters. The steps 902 and 914 are similar to the steps 714 and 728 described as part of FIG. 7 description. The steps 904 and 916 are similar to the steps 716 and 730 described as part of FIG. 7 description. The steps 906 and 918 are similar to the steps 718 and 732 described as part of FIG. 7 description. At 908, the user clicks on the optimized search button as opposed to the launch search button described as part of FIG. 7 description. Clicking optimized search button causes the SSE to present the optimization parameters applicable for the chosen category of advanced search at 920 which is similar to 814 described as part of FIG. 8 description. At 910, the user chooses the optimization parameters to be used in the search process. At 922, the SSE presents the search results to the user. The search result browsing, previewing and showcasing illustrated at 912 and 924 are similar to those described as part of FIG. 6 description. At 926, user browses through various search results, previews and showcases in order to find her desired product.

While the optimization methods used in optimized search as well as in optimized advanced search are similar, there is an important difference between them. In the case of basic optimized search, the optimization parameters presented to user 602 are chosen from all the categories where the search term could produce results; whereas in the case of optimized advanced search, the optimization parameters presented to the user are chosen from only the categories where the advanced search is desired.

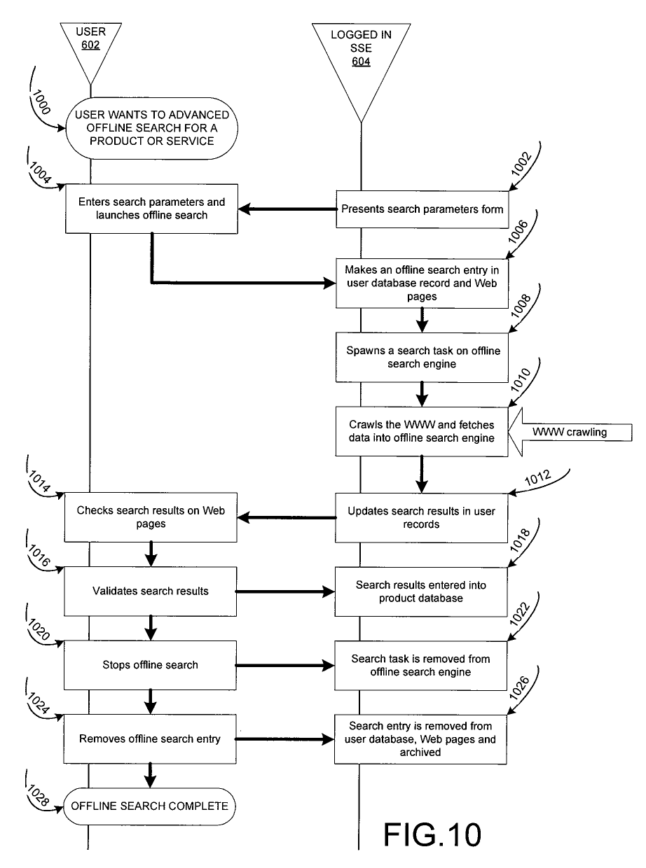

Reference is now made to FIG. 10, which is a simplified flowchart illustration of an example offline shopping search where a logged in user 602, interacts with a SSE 604 serving registered and logged in users for offline search. One aspect of the system requires interactions with a user along the process of the offline search, therefore, offline search works better for registered users. Offline search is a facility provided by SSE 604 to its users 604 who desires to search the WWW for products and services above and beyond the results provided by the SSE. One possible scenario where a user may desire so is when a satisfactory result is not found in search for a product or service. Another possible scenario where a user may desire an offline search is when a basic, advanced or optimized search produces no results. Although search algorithms described as part of the present system are optimized and tuned for shopping search, it is possible that the limited the number of results that are presented to a user fails to satisfy the user. Offline search provides means for understanding and acting towards the user requirements in shopping search.

At 1000, user 602 clicks on the offline search button embedded in search results or any other pages on SSE 604. At 1002, the user is presented with a form for entering the search term, any advanced or optimized search parameters, search duration, frequency of search, search notification and other parameters for executing an offline search. At 1004, the user clicks the launch search button after entering the offline search parameters. At 1006, the system makes an offline search entry into the user's offline-search-list field in user database 220 and a relevant list is created in user's Web pages. At 1008, SSE 604 spawns a task on offline search engine 210 for performing the search along with {user, offline search parameters}. The offline search engine 210 periodically wakes up for servicing incoming requests from the search application 212 and sends a crawl request with crawling-frequency, where crawling-frequency=offline-search-frequency/N and N is an integer greater than or equal to 1 to the crawling engine 204. At 1010, crawling engine 204 services the request as a specialized crawl, enters into its crawling-list and crawls WWW according to the parameters specified in offline search request. Data fetch by crawling due to offline search are sent to both product database 218 and offline search engine 210 by the crawling engine 204. The data is only entered into the product database 218 according the crawling policy of a product category. A crawling policy describes what and how data fetched by a crawling engine can be entered into the product database 218. For example, it may include the necessary attributes, source of data, possible matching categories and the like rules and those rules are checked against the data fetched by crawler prior to inserting those data into the product database 218. The crawling policy may be at the industry, sub-industry or product-category level, with the policy rules defined towards the leaf of the data hierarchy take precedence over the rules defined towards the root of the data hierarchy. For the data fetched that fail to satisfy the rules, may be subject to human analysis before discarding those data.

At 1012, offline search engine 210 receives crawled data and updates the user's search-results-list, which is a list that is part of each offline-search-list entry in user record. The search results are accumulated according to a selective overwrite policy where a more recent result overwrites an older result in case the crawler fetched similar data; however, if any parameter differs, the new parameters are appended to the existing entry. For example, the same product may be fetched from two different E-tailers. In this case, a single product entry will be used as the search results with two E-tailers offering it. If advanced parameters are specified, any products found that are not within the specified category are ignored in preparing offline search results; however, these results are considered for entering into product database 218. If optimization parameters are specified, the abstract and derived parameters are calculated against the existing products within the industry, sub-industry or product-category, as appropriate, prior to considering it as a potential search result. Any products found not compatible with the specified optimization parameters are ignored for the offline search; however, these results are considered for entering into product database 218.

At 1014, user 602 checks the offline-search-results list of her Web pages. If the time elapsed since the offline search launch is less than the frequency of search, there may not be any result prepared yet. Any time after the first frequency of search epoch has passed, offline search results are presented on user's offline-search-results list on her Web pages as they are found. The user may stop, interrupt or modify an active offline search at any time during the search and the search application 212 on SSE updates the offline search engine 210, crawling engine 204 and product database 218 accordingly. A user may launch multiple offline searches simultaneously. At 1016, user 602 may validate a search result by endorsing a result as a close or exact match of what she was searching for. A validated search result is added to product database 218 at 1018. At 1020, 602 elects to stop an offline search. At 1020, SSE 604 removes the corresponding offline search task from offline search engine 210 and search application 212. An offline search that is stopped is saved as a past-offline-search in user record in user database 220. At 1024, user 602 selects to remove an offline search entry. At 1026, SSE 604 removes the entry from current-offline-search or past-offline-search lists in user record and archives it. If an offline search is removed prior to stopping it, SSE 604 removes the corresponding offline search task from offline search engine 210 and search application 212 as well. At 1028, the offline search method is complete after the offline search entry is removed.

While offline search methods for shopping searches are useful in providing and satisfying shopper's needs closely, these can be used for general Internet and WWW search as well. One such search application would be where users are rarely connected to the Internet and whenever connected, the duration of the connection is short for performing extensive search and analyzing and browsing through search result while staying online. Such a user may register with an Internet search service provider and launch offline searches with one instance of Internet connection. Later, download the search results to a user device for browsing and analyzing further. Battlefields, rural areas and deserts are example of such transient Internet connections.

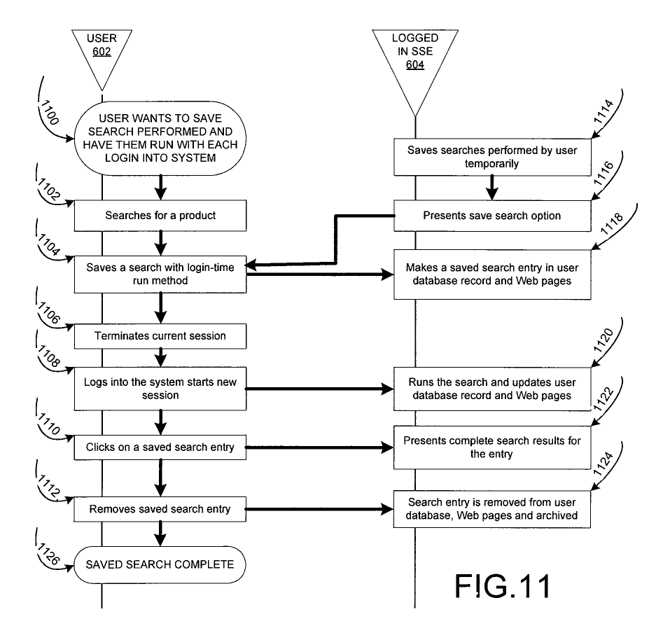

Reference is now made to FIG. 11, which is a simplified flowchart illustration of an example saved search method where a logged in user 602, interacts with a SSE 604 serving registered and logged in users as saving searches require a user record in SSE as a storage means. One embodiment of the presented system saves all types of searches performed by users temporarily at 1114. At 1100, a user wants to search and then save the searches for running them automatically with each time the user logs into the system or at some regular intervals. At 1102, the user searches using one of the search methods described above. At 1116, the SSE presents the option to save a search when the search results are produced and presented to the user. At 1104, the user chooses to save the search and specifies the parameters of saving, such as duration, run method, e.g. login time, regular-interval and the like. At 1118, the system makes a saved search entry into the user's saved-search-list field in user database 220 and a relevant list is created in user's Web pages. At 1106, user 602 terminates her session with the SSE and at 1108, user 602 logs into SSE 604. At 1120, the SSE automatically runs the search for each entry in user's saved-search-list field in user database 220 if the login time method of running is specified for an entry and then updates the user's search-results-list, which is a list that is part of each saved-search-list entry in user record. For regular interval run method, searches are at the specified interval and updated in user database 220. Regular interval run method is suitable for active users using the system whereas login time run method is suitable for most users.

The saved-search-list is suitably displayed in user's Web pages with convenient viewing of the results that are generated at the user login time. Each entry in the saved-search-list is hyper-linked with a separate button or hyper-link for removing the entry. Clicking the entry hyper-link causes the SSE to suitably present the search results of that search entry whereas clicking the remove hyper-link or button causes a saved search to be removed from the user record and user Web pages. At 1110, user 602 clicks on a saved-search-list entry and at 1122, the SSE presents complete search results for the entry. A user can add and remove saved search results at will and have multiple saved searches simultaneously. At 1112, the user selects to remove a saved search by clicking on the remove button or hyper-link. At 1124, the SSE removes the saved search requested at 1100 from user's saved-search-list. One example embodiment may maintain a history of saved searches and move the entry into an saved-search-archive-list in user record. A saved search entry is removed automatically by the SSE from the saved-search-list of a user if duration is specified and when the period of the duration from the search saving time expires. At 1126, the saved search method is complete after the saved search entry is removed.

Saving searches and having them run by the SSE at later time is a useful tool for shoppers who are shopping for products with longer times allocated for shopping, such as a week or a month. The dynamic nature of one example embodiment's products, product rankings and the ranking factors are likely to present search results in different orders as well as add newly added products as well as remove obsolete products. This also allows users to view all such items in a single place for analyzing and researching all the relevant offerings over a period of time. Another relevant aspect of this feature is the ability to save search results that allows users to save the actual search results at the time when they are produced. When saved searches are used in conjunction with saved search results, it is possible to compare the results and understand any trend or change in the market. Together, they provide powerful means for deciding the correct time for purchasing a desired product. The saved search results method is described below.

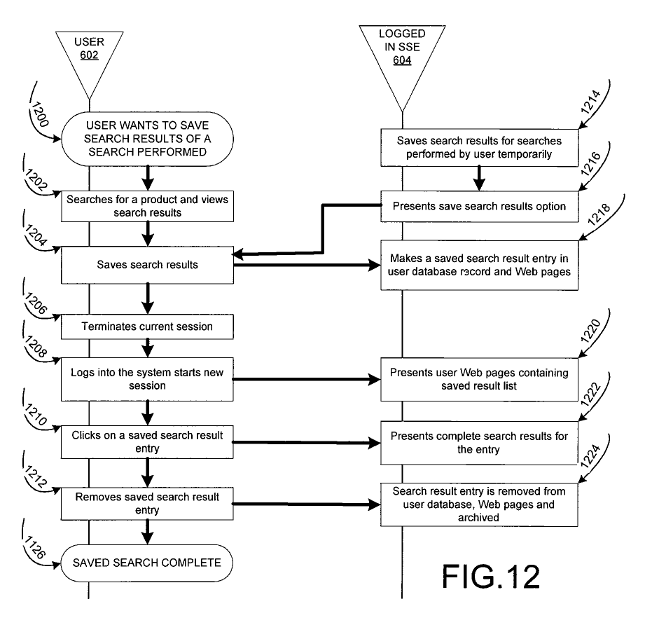

Reference is now made to FIG. 12, which is a simplified flowchart illustration of an example saved search results method where a logged in user 602, interacts with a SSE 604 serving registered and logged in users as saving search results require a user record in SSE means of search results storage. At 1200, a user desires to save the results of a search performed. User steps 1202 and 1204 and SSE steps 1214, 1216 and 1218 are similar to searching and saving searches described as part of FIG. 11 description above, except that search results are saved instead and into a saved-search-results-list field in the user record in user database 220 along with search-term or any other suitable title for each list entry. Another difference is that there is no method to run a process needed for saving search results. At 1206, user 602 terminates her session with the SSE and at 1208, user 602 logs into SSE 604. The steps 1210 and 1212 are similar to viewing and presenting saved searches described as part of FIG. 1 1 description above, except that search is not run when the user logs into the system or at any other time. The search results are presented by the SSE at 1220 along with a hyper-linked title and a hyper-link or button for removing a saved search result. Step 1222 of presenting complete search results for an entry and 1224 of removing a saved search result entry are similar to the presentation of search results and removal of search entries described as part of FIG. 11 description above.

While the methods of saving searches and search results are particularly useful in online shopping search, similar methods or variations can be used in general Internet and WWW search as well. A user of general web search may benefit by saving searches performed on a search service provider site and then having the provider site run the saved searches with every login if some frequent searches are always performed by the particular user. A user of a map search may benefit by saving regular destination searches performed on a dynamic map search provider site that provides shortest, quickest or safest street routes based on real-time and near real-time traffic and road conditions and then having the provider site run the saved searches with every login. The user may login at different times of a day for getting the optimal routes to the same saved destination.

FIG. 13 illustrates an example product showcase page that demonstrates a Web page displayed to a user 112 by access device 110 connected to a CSE operating in accordance to at least one aspect of the present system over a network. Among the features of the CSE is the manner in which information is presented on the product showcase pages. The page contains a search window 1300 similar to the search window described as part of FIG. 5 description above. A showcase window 1304 shows a possible first page when showcasing a product consisting of prime attributes of the product 1308, brief description of the product 1310, top features of the product 1312 and an anchor image 1314. Also contained in the showcase pages is a tab panel 1302, which allows a user to navigate through different information about a product. The benefits of using a tab panel based showcase are described above as part of FIG. 6 description. The purpose of the anchor image is to display the image as the representative image across all tabs.

Also contained in the showcase page is a product intelligence panel 1306, which contains various related products and product categories. The home category is where the product is attached to in the product database 218. The related categories are where similar or related products may exist in product database 218. The constituent products are products that are directly contained within this product while dependent products are products that directly or indirectly depend on this product for being viable for purchase to a buyer of this product. Relevant products are those that are neither constituent nor dependent on this product, yet have beneficial relation to this product. For example, software upgrade for a digital camera printer which is neither constituent nor dependent as such yet relevant and interesting to this product. Competing products are the products with similar product ranks within the same product category. Some of the example constituent, dependent, relevant and competing products for the “Canon EOS 40D Digital SLR Camera” are shown on FIG. 13. In order to identify appropriate constituent, dependent, relevant and competing products, database links are created based on manufacturer, distributor, E-tailer, interesting and third party sites and user provided product information.

At the end of a shopping search and when a search result details are desired by a user, the product showcase is presented. One of the tabs in product showcase lists the E-tailers offering the product with their offerings, such as price, discount and service details.

### Automated Buying, Paying and Shipping.

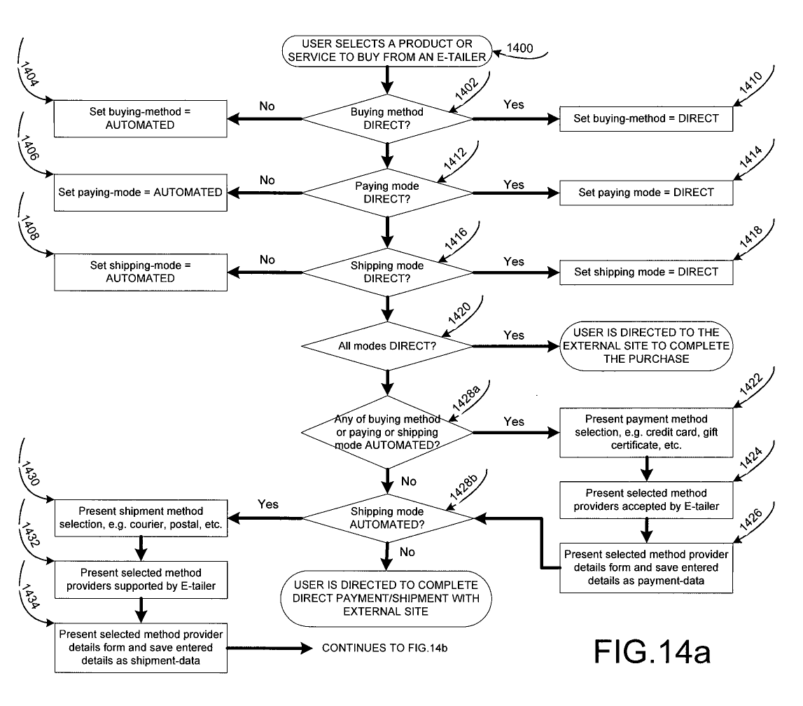

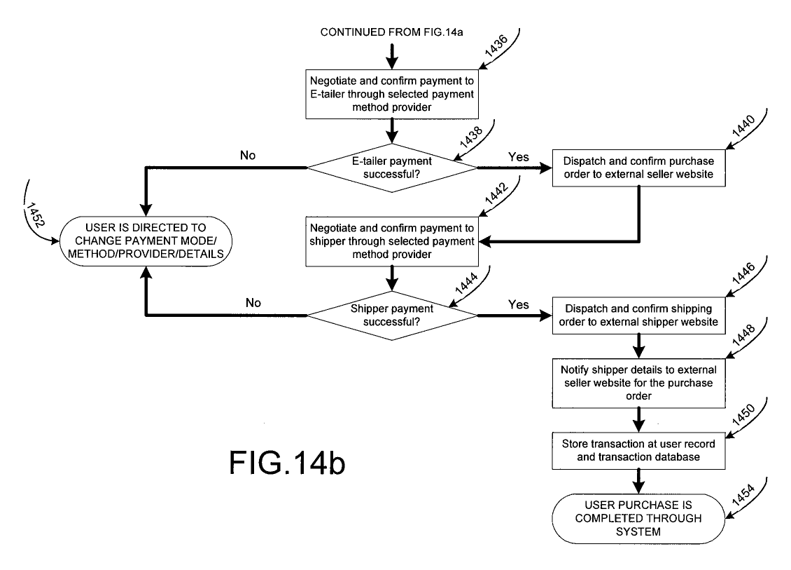

Reference is now made to FIG. 14a and FIG. 14b, which is a simplified flowchart illustration of an example automated buying, paying and shipping methods described as at least one aspect of an example embodiment. At 1400, a user 602 selects an E-tailer to purchase a product or service from; we denote this product or service as an ‘item’, which is a structure in memory of purchase application 242 for holding all transaction-related data for the purchase temporarily. At 1402, the user is presented with a form for selecting the buying method: 1) directly from E-tailer; 2) through the CSE; or 3) any other, and she selects the buying method. If the buying method is selected to be from the E-tailer directly, item's buying method is set to DIRECT at 1410, otherwise it is set to AUTOMATED at 1404. At 1412, the user is presented with a form for selecting the paying mode: 1) directly to the E-tailer; 2) through the CSE; or 3) any other, and she selects the paying mode. The user chooses to either pay through the CSE or directly to the E-tailer. If the paying mode is selected to be directly to the E-tailer, item's paying mode is set to DIRECT at 1406, otherwise it is set to AUTOMATED at 1414. The user is next presented with a form for selecting the shipping mode: 1) directly through the E-tailer; 2) through the CSE; or 3) any other, and she selects the shipping mode at 1416. If the user chooses to ship through the E-tailer directly at 1418, item's shipping method is set to DIRECT, otherwise it is set to AUTOMATED at 1408. If all of items buying method, and paying and shipping modes are set to DIRECT, it means that the user would like to complete the purchase including payment and shipment through the E-tailer directly. The user is directed to the E-tailer site at 1420 accordingly.

If the user was not directed to the E-tailer site, following checks are performed at 1428 for determining the next form to be presented to the user:
1) If the item's buying method is AUTOMATED;
2) If the item's buying method is DIRECT, but both paying and shipping modes are AUTOMATED;
3) If the item's buying method and paying mode are DIRECT and shipping mode is AUTOMATED; or
4) If the item's buying method and shipping mode are DIRECT and paying mode is AUTOMATED
   If any of the checks above pass, user 602 is presented a form for selecting the payment method at 1422, which is for the purchase and shipping in the cases of checks 1 and 2; purchase only in the case of check 4 and shipping only for check 3. For the cases 1 and 2, an example embodiment may offer using a single payment method for both E-tailer and shipper whereas another example embodiment may offer using different payment methods for E-tailer and shipper. By the latter embodiment, steps 1424 and 1426 should be repeated for each recipient of the payment—E-tailer and shipper. At 1424, the user is presented with a form based on the accepted methods of payment by the E-tailer, such as a credit card, a debit card, promotional points, gift certificates, coupons or any other payment form and providers of each type of payment method. At 1426, user selects the payment method and enters the details for the method. For a credit card based payment, the method details may include the credit card number, expiry date, billing address, security code and the like. In one example embodiment, the user may save her preferred methods of payments and method details in her profile in user record of user database 220. User saved and preferred payment methods may be checked by the CSE against the E-tailer accepted methods and prompt the user to select her saved methods along with options for entering and/or saving a new method as well.

If checks 1, 2 or 3 at 1428 pass, user 602 is presented with a form based on supported methods of shipment by the E-tailer, such as courier, postal, trucking and provider for each type of shipment method at 1430. At 1432, user selects the shipment method and enters the details for the method at 1434. For a courier shipment, the method details may include the service type, delivery mode, shipping address and the like. In one example embodiment, the user may save her preferred methods of shipments and method details in her profile in user record of user database 220. User saved and preferred shipment methods may be checked by the CSE against the E-tailer accepted methods and prompt the user to select her saved methods along with options for entering and/or saving a new method as well.

At 1436, CSE 604 negotiates E-tailer payment in the cases of checks 1, 2 and 4 passing at 1428, through the appropriate payment authorizer of the payment method and the provider selected at 1426. If the authorization is successful at 1438, the purchase order is dispatched to the E-tailer at 1440. If the authorization is not successful at 1438, user is prompted for entering new payment details at 1452 similar to 1424 along with the return code of the unsuccessful authorization from the payment authorizer. In an example embodiment a user may be allowed a finite number of attempts before aborting the payment process and possibly storing the transaction for fraud and other analysis of any repeated unsuccessful payment attempts.

At 1442, CSE 604 negotiates shipper payment in the cases of checks 1 and 2 passing at 1428 and E-tailer payment authorization success at 1438; or check 3 passing at 1428 alone, through the appropriate payment authorizer of the payment method and the provider selected at 1426. If the authorization is successful at 1444, the shipping order is dispatched to the shipper at 1446. If the authorization is not successful at 1444, the user is prompted for entering new payment details at 1452 similar to 1424 along with the return code of the unsuccessful authorization from the payment authorizer. In an example embodiment a user may be presented with a finite number of attempts before aborting the payment process and possibly storing the transaction for fraud and other analysis of any repeated unsuccessful payment attempts.

At 1448, CSE 604 sends the shipment details notification for the purchase order sent earlier to the E-tailer. Appropriate purchase order identifier and shipment order identifier is included in the notification so that the E-tailer can associate a shipment details to the correct purchase order. At 1450, the transaction is stored to user's completed purchase history in user record in user database 220 and the transaction itself is stored in a transaction record with details, such as the user, E-tailer, shipper, payment method, shipment method, payment authorizer and authorization data and the like in transaction database 230. At 1454, the automated buying, paying and/or shipping methods complete after the transaction record is stored in transaction database 230.

While the automated buying, paying and shipping methods on a CSE is described above, variations of the order is possible. Certain embodiments may combine, omit or include certain steps. Certain steps may be performed in different orders than the order described above. For example, a single purchase order with shipment details may be sent to an E-tailer once shipment payment authorization is complete instead of twice as described above.

### Proxy Registrations and Security Associations.

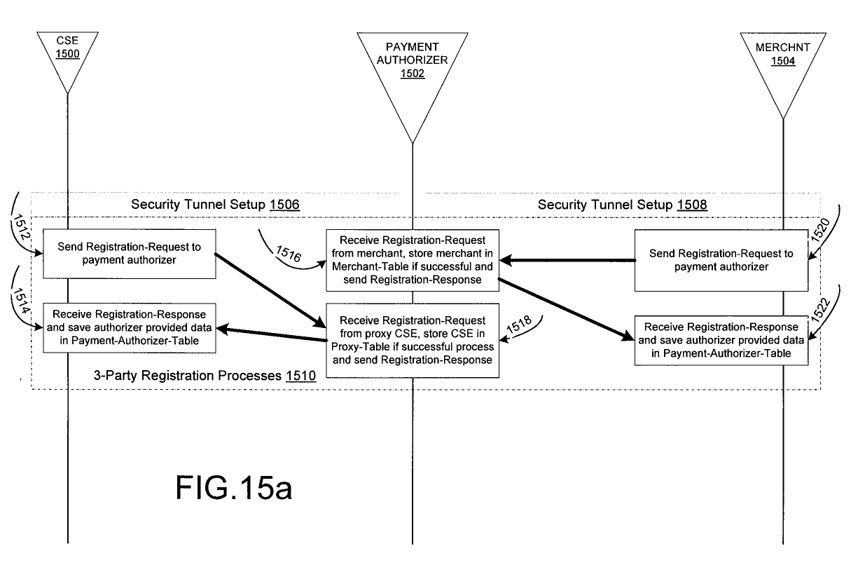

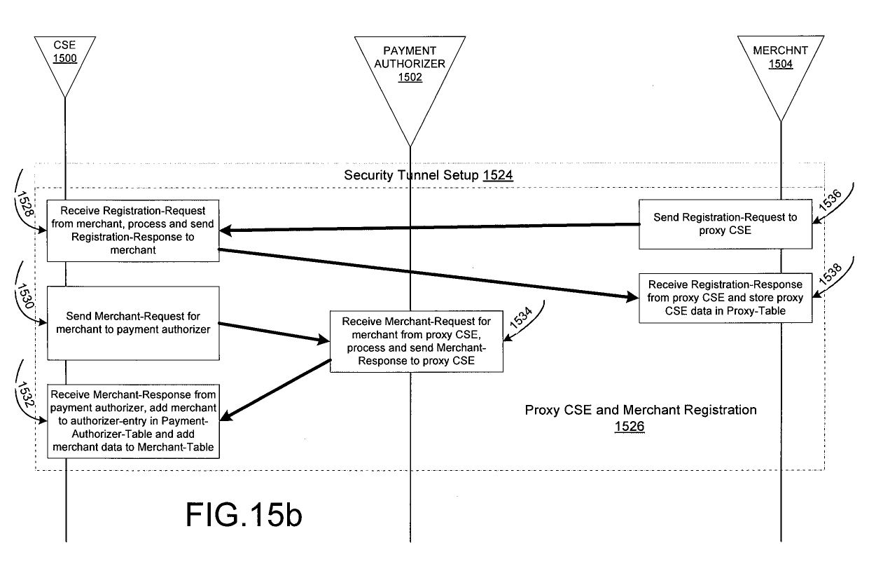

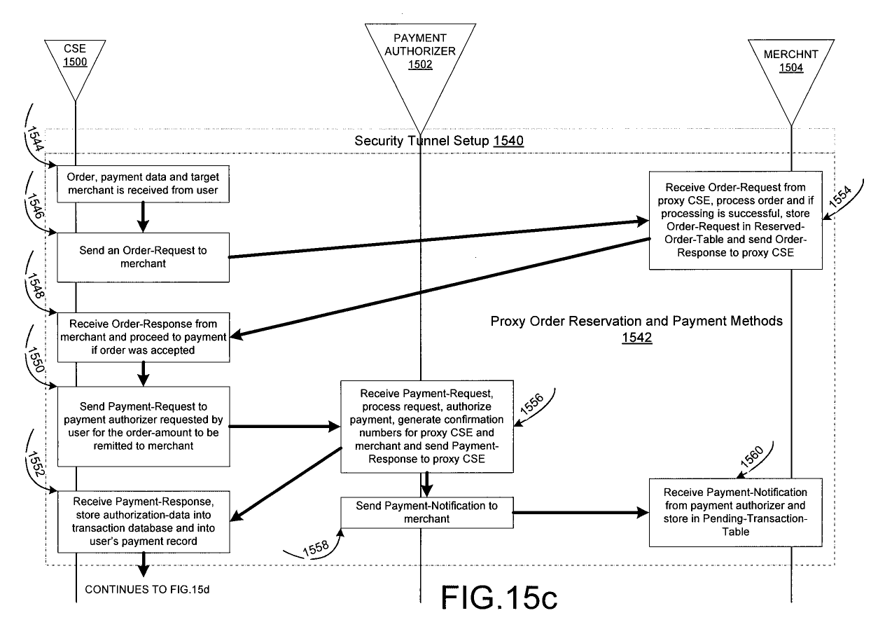

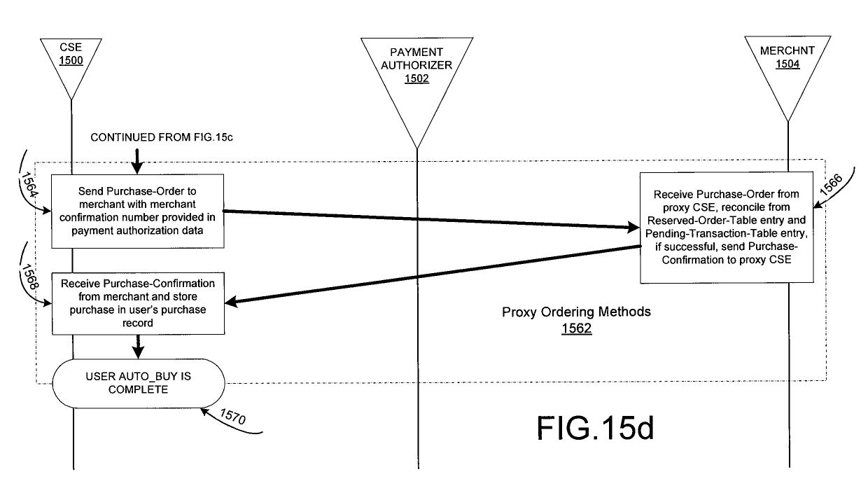

Reference is now made to FIG. 15a and FIG. 15b, which constitute a simplified flowchart illustration of an example proxy payment registration and security association setup methods described as at least one aspect of the presented system. The protocol includes three entities: a CSE 1500, a payment authorizer 1502 and a merchant 1504, all operating in accordance to at least one aspect of the presented system. The box 1506 describes a secure tunnel setup between CSE 1500 and payment authorizer 1502 and the box 1508 describes a secure tunnel setup between the merchant 1504 and payment authorizer 1502. Those who are skilled in relevant art(s) would appreciate that setting up secure tunnels between network entities are intended for protecting communication between the tunnel endpoints and there are methods well-known for performing the task. The type of tunnel and the layer of tunnel operation depend on at which layer of TCP/IP or a similar network protocol stack, e.g. Open System Interconnect (OSI). If communication occurs at the transport layer, a.k.a. Layer-4, an IPSec tunnel is appropriate. If communication occurs at the application layer, a.k.a. Layer-5, a TLS or SSL tunnel is more appropriate. A guiding principle can be that a security tunnel at the layer-{communication-layer−1}, Layer-3 when communication-layer=Layer-4 or Layer-4 when communication-layer=Layer-5 should protect the communication adequately. In this illustration, communication occurs at application layer (layer-5), implying a TLS or SSL tunnel is suitable for both tunnels in boxes 1506 and 1508. The application layer communication may occur using a transport protocol, such as TCP and a specific port dedicated for the application and all entities use dedicated application servers for accessing protocol data embedded into the TCP packets. It may also occur using the HTTP where all entities may use a web server in order to communicate with each other prior to accessing protocol data embedded into the HTTP packets. The protocol data may be included in suitable format, such as extensible Markup Language (XML) or a variation of XML. The protocol data may also result in Remote Procedure Call (RPC) or Simple Object Access Protocol (SOAP) like invocations on the recipient ends.

The box 1510 comprises the CSE<>Payment authorizer and Merchant<>Payment authorizer registrations. All communications illustrated in this box occurs over the security tunnel setup in boxes 1506 and 1508 respectively. CSE 1500 stores the payment authorizers in its user database 220. For communicating with payment authorizers, appropriate authorizers are fetched from user database 220 to auto_pay engine 226 memory and stored temporarily in a payment-authorizer-table. At 1512, CSE 1500 sends a Registration-Request to the payment authorizer 1502. The Registration-Request includes a proxy-identifier and a set of proxy-credentials, which may include proxy-name, proxy-location, proxy-code, proxy-hash and other information as required by payment authorizer for completing registration. At 1518, payment authorizer 1502 receives the Registration-Request, checks its proxy acceptance policies and sends a Registration-Response to CSE 1500. If the registration is accepted by the payment authorizer 1502, the payment authorizer generates a unique proxy-key using proxy-identifier and/or at least one proxy credential and/or authorizer-identifier, and stores this proxy along with its credentials and proxy-key in its proxy-table. The proxy-key is included in Registration-Response along with an authorizer-identifier in the case of an accepted registration; an error code, e.g. zero in case of an unaccepted registration. Similar to CSE 1500, payment authorizer 1502 may use a database for storing the proxy payers and memory for storing proxy-table. At 1514, CSE 1500 receives the Registration-Response and if the registration is accepted, stores the authorizer-identifier along with the proxy-key in its payment-authorizer-table stored in auto_pay engine 226 data memory. For an unaccepted registration, CSE may re-try the registration process with the same or a different payment authorizer. In any case, CSE may analyze the error code and correct it prior to re-sending the Registration-Request.

At 1520, merchant 1504 sends a Registration-Request to the payment authorizer 1502. The Registration-Request includes a merchant-identifier and a set of merchant-credentials, which may include merchant-name, merchant-location, merchant-code, merchant-hash and other information as required by payment authorizer for completing registration. At 1516, payment authorizer 1502 receives the Registration-Request, checks its merchant acceptance policies and sends a Registration-Response to CSE 1500. If the registration is accepted by the payment authorizer 1502, the payment authorizer generates a unique merchant-key using merchant-identifier and/or at least one merchant credential and/or authorizer-identifier, and stores this merchant along with its credentials and merchant-key in its merchant-table. The merchant-key is included in Registration-Response along with an authorizer-identifier in the case of an accepted registration; an error code, e.g. zero in case of an unaccepted registration. Similar to CSE 1500, merchant 1504 may use a database for storing the payment authorizers and memory for storing payment-authorizer-table. At 1522, merchant 1504 receives the Registration-Response and if the registration is accepted, stores the authorizer-identifier along with the merchant-key in its payment-authorization-table stored in data memory. For an unaccepted registration, merchant may re-try the registration process with the same or a different payment authorizer. In any case, merchant may analyze the error code and correct it prior to re-sending the Registration-Request.

As merchant and payment authorizer may have existing payment authorization arrangements setup, one example embodiment of the presented system may choose the existing arrangement. The payment authorizer may generate a merchant-key based on existing arrangements and merchant data for use as part of the proxy payment protocol and send an unsolicited Registration-Response like message, such as Merchant-Key-Message to the merchant.

Box 1524 represents a secure tunnel setup between CSE 1500 and merchant 1504 and the procedure is similar to the box 1506 and 1508 described above. The box 1526 comprises the CSE<>merchant registration and CSE<>payment authorizer merchant confirmation. All communications illustrated in this box occurs over the security tunnel setup in box 1524. At 1536, merchant 1504 sends a Registration-Request to CSE 1500. The Registration-Request includes the merchant-identifier, payment-authorizer-identifier and a hash code generated using its merchant-key received at 1522 from the payment-authorizer 1504 of its {merchant-identifier, merchant-credentials}. This hash code is denoted as “merchant-hash”. CSE 1500 stores the merchant in its user database 220 where each merchant entry in the database contains a list of accepted payment-authorizers and supported shippers. For communicating with merchants, appropriate merchants are fetched from user database 220 to auto_buy engine 222 memory and stored temporarily in a merchant-table. At 1528, CSE 1500 receives the Registration-Request sent by the merchant, checks its merchant-table using the merchant-identifier in the request. If a matching merchant is found, payment-authorizer-identifier is matched against the list of accepted payment-authorizer for this merchant. If a matching payment-authorizer is found, the hash code from the request is stored as part of this payment-authorizer in the merchant entry in auto_pay engine 226 memory. A Registration-Response is then sent to the merchant. The Registration-Response includes the proxy-identifier, payment-authorizer-identifier a hash code generated using its proxy-key received at 1514 from the payment-authorizer 1504 of its {proxy-identifier, proxy-credentials}. This hash code is denoted as “proxy-hash”. If a matching merchant is not found using the merchant-identifier received in a Registration-Request, one example embodiment may choose not to respond to the request. Another example embodiment may choose to respond with an error code. If a matching payment-authorizer is not found using the payment-authorizer-identifier received in a Registration-Request, one example embodiment may choose not to respond to the request. Another example embodiment may choose to respond with an error code. Yet another example embodiment may choose to respond with a payment-authorizer-identifier extracted from the list of accepted payment-authorizers of this merchant.

At 1538, the merchant 1504 receives a Registration-Response from CSE 1500 and if the response message contains a valid proxy-identifier to which the corresponding request was sent to and a valid payment-authorizer-identifier which was included in the corresponding request, the proxy-identifier in the response is used to find the proxy record for the CSE. The hash code from the response is stored in the proxy record. The merchant 1504 may have a database and/or memory in its system where the proxy record is stored. If an invalid or different than the corresponding request proxy-identifier is received in the response, the Registration-Response is discarded.

In an example embodiment, in order for hash code to work properly, the constituents of merchant-hash, i.e. merchant-identifier and merchant-credentials and the constituents of proxy-hash, i.e. proxy-identifier and proxy-credentials should be the same on all entities 1500, 1502 and 1504. In one example embodiment, a pre-set agreement of the set of parameters to include in credentials and persistent usage of identifiers may ensure identical constituents of the hash code. In another example embodiment, a pre-negotiation phase can be used for the parameters of the hash code. Hash codes are well known in relevant art(s) and there are several mathematical hash functions commonly used in network security, such as Hash Message Authentication Code (HMAC), Secure Hash Algorithm (SHA-1, SHA-256), Message Digest Algorithm (MD4, MD5), etc.

Once merchant<>CSE registration is complete, a Merchant-Request message is sent by CSE 1500 to payment-authorizer 1502 at 1530. This message includes proxy-identifier, {merchant-identifier and merchant-hash} encrypted with proxy-key received from payment-authorizer 1502 at 1514. At 1534, the payment-authorizer 1502 receives the Merchant-Request message from CSE 1500, extracts merchant-identifier and merchant-hash by decrypting the partial message using the proxy-key saved at 1518 of the proxy-identifier in the message. It then looks up its merchant-table using the merchant-identifier in the message. If a matching merchant is found, it calculates the hash code of {merchant-identifier, merchant-credentials from merchant-table}. If the calculated hash code matches the hash code in the message, it generates a unique proxy-merchant-key using the proxy-identifier, merchant-identifier, and/or authorizer-identifier, and/or proxy-credentials, and/or merchant-credentials and stores this key in both merchant entry in merchant-table and proxy entry in proxy-table. It then sends a Merchant-Response message to CSE 1500. The message includes payment-authorizer-identifier and {merchant-identifier, proxy-merchant-key} encrypted using proxy-key. If a matching merchant is not found using the merchant-identifier received in a Merchant-Request, one example embodiment may choose not to respond to the request. Another example embodiment may choose to respond with an error code. If the calculated and received hash codes do not match, one example embodiment may choose not to respond to the request. Another example embodiment may choose to respond with an error code.

At 1532, CSE 1500 receives the Merchant-Response message from payment-authorizer 1500 and if the message contains a valid authorizer-identifier, the authorizer is looked up using this identifier. The partial message is then decrypted using the proxy-key stored in the authorizer record in its payment-authorizer-table stored in auto_pay engine 226 data memory. It then looks up the merchant in its merchant-table stored in auto_buy engine 222 data memory using the merchant-identifier of the message. If a matching merchant is found, the proxy-merchant-key is stored in this merchant record for this payment-authorizer. Optionally, this key may be stored in the merchant entry of the list-of-merchants for this authorizer record stored in payment-authorizer-table. If a matching payment-authorizer is not found using the authorizer-identifier received in a Merchant-Response, one example embodiment may choose not to respond to the request. Another example embodiment may choose to respond with an error code. If a matching merchant is not found using the merchant-identifier received in a Merchant-Response, one example embodiment may choose not to respond to the request. Another example embodiment may choose to respond with an error code.

At the end of 1532, registration methods between CSE 1500, payment authorizer 1502 and merchant 1504 are complete for as long as the security association persists, which may be indefinite or only until one of the devices restarts. When the security association no longer valid, each entity can independently remove the security association with both or any other entity and not participate in a proxy payment protocol until another security association is setup. This ensures high-level of security, integrity, confidentiality and protection of customer and merchant's personal, financial and other information. Unlike most other secure payment protocols, the registration and security association methods described above is a true three-party security association protocol where the registration bootstrapping occurs in a security tunnel and all sensitive messages within the tunnel are encrypted as well as cryptographically signed as appropriate.

### Proxy Payment and Proxy Ordering Methods.

Reference is now made to FIG. 15c and FIG. 1 5d, which constitute a simplified flowchart illustration of an example proxy payment and ordering protocol described as at least one aspect of the presented invention. Box 1540 represents a secure tunnel setup between CSE 1500 and merchant 1504 and the procedure for establishing the secure tunnel is similar to the box 1506 and 1508 described above. This setup should only be needed if the previous secure tunnel was removed after the registration methods between CSE 1500 and merchant 1504. The box 1542 illustrates the order reservation and proxy payment methods.

At 1544, a user selects the E-tailer and a payment method provider, details of which are described as part of FIG. 14a description above. At 1546, CSE 1500 sends an Order-Request message to merchant 1504. The message includes proxy-identifier, order-identifier, order-details and proxy-hash. At 1554, the merchant 1504 receives Order-Request message from CSE 1500. It first checks that it has a security association with this CSE and that a proxy-hash exists for it by looking up its proxy-table using the proxy-identifier received in the message. If the stored proxy-hash matches the proxy-hash received in the message, the order is processed further. Otherwise, the order may be discarded silently or an Order-Response may be sent with an invalid order-confirmation-number. Order-details are checked to ensure that the order can be accepted. These checks may include whether the requested item is in stock, whether it is shippable, whether requested price and discount is acceptable and the like. If the order passes the acceptance checks, a reserved-order entry is created in merchant's reserved-order-table with {order-confirmation-number, proxy-identifier} and an Order-Response message is sent to CSE 1500. The message includes merchant-identifier, order-confirmation-number and merchant-hash. A merchant may choose to hold a reserved-order for a finite period of time before expiring and deleting it.

At 1548, CSE 1500 receives Order-Response message from the merchant 1504. It first checks that it has a security association with this merchant and that a merchant-hash exists for it by looking up its merchant-table using the merchant-identifier received in the message. If the stored merchant-hash matches the merchant-hash received in the message, the order-confirmation-number is stored in user's transactional item stored in data memory of auto_buy engine 222. Otherwise, the response may be discarded and the user is notified accordingly of the missing security association with the desired merchant. In this case, one example embodiment may choose to suggest another merchant to the user for the same product with whom a valid security association exists on the CSE. Another example embodiment may choose to suggest the user to complete the purchase directly with the merchant.

At 1550, CSE 1500 sends a Payment-Request message to the payment authorizer. The message includes proxy-identifier, merchant-identifier, {user-details, payment-method-details, amount} encrypted using proxy-merchant-key. At 1556, the payment authorizer 1502 receives the Payment-Request message from CSE 1500. It first checks that both proxy and merchant are registered and each has a valid security association by looking up the proxy in its proxy-table using the proxy-identifier received in the message and the merchant in its merchant-table using the merchant-identifier received in the message. If a valid proxy and in the proxy record, a valid proxy-key and a valid merchant and in the merchant record, a valid merchant-key is found, the merchant is looked up in proxy's secure merchant-list and proxy is looked up in merchant's secure proxy-list. Each of these look ups should point to a proxy-merchant-key and they must match. If they match, this key is used to decrypt the partial message containing user-details, payment-details and amount. Any of the following error conditions may result in one embodiment of the presented invention either silently discarding the request or responding with an error code (at least one error condition may indicate possible security breach and fraudulent activities):
1. Invalid proxy-identifier
2. Invalid merchant-identifier
3. Invalid proxy-key
4. Invalid merchant-key
5. Non-existent merchant in proxy record
6. Non-existent proxy in merchant record
7. Proxy-merchant-key mismatch

User details received in Payment-Request message includes user's full name, phone number, billing address and the like; while payment-details includes credit card number, expiration date, security code for a credit card method; and debit card number, issuing bank, expiration date, etc. for a debit card method. The payment authorizer may use its regular methods, which are well known in relevant art(s) for authorizing the payment for the amount, from the user, to the merchant. If the authorization is successful, a Payment-Response message is sent to CSE 1500. The message contains authorizer-identifier, merchant-identifier, {proxy-confirmation-number, merchant-confirmation-number, authorization-details} encrypted with proxy-merchant-key. Authorization-details may include the following information or as appropriately specified by the payment authorizer:
1. Date and time of authorization
2. Result code
3. Respond code
4. Authorization type
5. Authorization number
6. Reference number
7. Approval number
8. Transaction identifier
9. Issuer, e.g. card, promotional points, gift certificate, coupons and the like
10. Card member
11. Amount

At 1552, CSE 1500 receives Payment-Response message from the payment authorizer 1502. It first checks that it has a valid security association with each of payment authorizer and merchant by looking up the payment authorizer in its payment-authorizer-table using the authorizer-identifier received in the message residing in data memory of auto_pay engine 226 and the merchant in its merchant-table using the merchant-identifier received in the message residing in data memory of auto_buy engine 222. If a valid authorizer, the merchant in its list-of-merchants; and a valid merchant and the authorizer in its list of accepted payment-authorizers is found, a proxy-merchant-key should be located in both entries and they must match. If they match, this key is used to decrypt the partial message containing proxy-confirmation-number, merchant-confirmation-number, authorization-details. Any of the following error conditions may result in one embodiment of the presented invention silently discarding the response (at least one error condition may indicate possible security breach and fraudulent activities):
1. Invalid authorizer-identifier
2. Invalid merchant-identifier
3. Non-existent merchant in authorizer record
4. Non-existent authorizer in merchant record
5. Proxy-merchant-key mismatch
   If the partial message is successfully decrypted, transaction-details consisting of {proxy-confirmation-number, merchant-confirmation-number, authorization-details} is entered with a unique transaction-identifier into the transaction database 230. This transaction-identifier should be a large value in order to uniquely identify a transaction without reusing the identifier space. The transaction-identifier is then entered into the user's payment-transaction-history in user record of user database 220. If authorization-details indicate a successful payment authorization, auto_pay engine 226 sends an IPC message consisting of {user-details, merchant-details, merchant-confirmation-number} to the auto_buy engine instructing it that payment is authorized that the automated purchase can proceed. If authorization-details indicate an unsuccessful payment authorization, auto_pay engine 226 sends an IPC message to the purchase application indicating the failure so that the purchase application may present the result to the user. As described as part of FIG. 14b description above, a user may be requested to enter a different method or mode of payment or abort the transaction by one example embodiment. The purchase application 242 communicates with auto_pay engine 226 according to user's requests. If the user chooses to abort the transaction or the payment authorization is unsuccessful after N attempts, where N>1, the transaction is aborted from auto_pay engine 226 and it instructs auto_buy engine 222 to abort the purchase.

If payment authorization was successful at 1556, payment authorizer 1502 sends the Payment-Notification message to merchant 1504 at 1558. The message includes authorizer-identifier, {proxy-identifier, merchant-confirmation-number, amount} encrypted using merchant-key. At 1560, merchant 1504 receives Payment-Notification. It first checks that it has a valid security association with the payment authorizer, by looking up its payment-authorizer-table using the authorizer-identifier from the message. If an authorizer is found and a valid security association exists with this authorizer, the merchant-key stored in this authorizer record is used to decrypt the partial message. If the message is successfully decrypted, the proxy-identifier is extracted from the message and looked up in the proxy-table for a valid CSE as well as a valid security association with the CSE. If a valid proxy and a valid security association exist for the proxy, a transaction is created in its pending-transaction-table consisting of the merchant-confirmation-number and amount. Any of the following error conditions may result in one embodiment of the presented system silently discarding the notification (at least one error condition may indicate possible security breach and fraudulent activities):
1. Invalid authorizer-identifier
2. Non-existent valid security association with payment authorizer
3. Invalid proxy-identifier
4. Non-existent valid security association with proxy
   A merchant may choose to hold a transaction for a finite period of time before expiring and deleting it. The box 1562 illustrates the final ordering process as part of the automated purchase. When the IPC message is received from auto_pay engine 226 at auto_buy engine 222 at 1552, auto_buy engine initiates 1564, where CSE 1500 sends Purchase-Request message to the merchant 1504. The message includes proxy-identifier, order-confirmation-number obtained at 1548, merchant-confirmation-number obtained at 1552, amount and proxy-hash. Auto_buy engine 222 on CSE 1500 stores the pending-order in its pending-order-table with {user, merchant} and order-confirmation-number as the key. At 1566, the merchant 1504 receives the Purchase-Request message. The merchant 1504 first looks up the proxy in its proxy-table using proxy-identifier. If a valid proxy is found and a valid proxy-hash exists, it is matched against the proxy-hash received in the message. If a match is found, the order-confirmation-number is used to lookup the reserved-order-table. If a reserved-order is found in this table, the proxy-identifier stored in this entry is matched against the proxy-identifier received in the message. If a match is found, the merchant-confirmation-number is used to lookup the transaction from the transaction-table. If a valid transaction is found, the purchase order is accepted. The order-details from the reserver-order and transaction-details from the transaction is used to create a confirmed-order into an order-table by the merchant 1504. Any of the following error conditions result in the merchant 1504 to send a Purchase-Response with appropriate error code (at least one error condition may indicate possible security breach and fraudulent activities):
1. Invalid proxy-identifier
2. Non-existent valid security association with proxy
3. Proxy hash mismatch
4. Invalid order-confirmation-number
5. Proxy-identifier mismatched in order-confirmation-number
6. Invalid merchant-confirmation-number
7. Amount mismatch between payment authorization and purchase order
   Once an order is successfully processed by a merchant 1504, a successful Purchase-Response message it sent to CSE 1500. The message includes merchant-identifier, order-confirmation-number, merchant-hash. At 1568, CSE 1500 receives the message and first checks that is has a valid merchant in its merchant-table by looking up the table using merchant-identifier received in the message. If a valid merchant is found and a valid merchant-hash exists, it is matched against the merchant-hash received in the message. If a match is found, the order-confirmation-number is used to lookup its pending-order-table. If a valid pending-order is found, the purchase is considered complete and a completed-order entry is created in with a unique purchase-identifier into transaction database 230. This purchase-identifier should be a very large value. The purchase-identifier is then entered into the user's purchase-transaction-history in user record of user database 220. Any of the following error conditions result in CSE 1500 to abort a purchase and undo any associated payment with it (at least one error condition may indicate possible security breach and fraudulent activities):
1. Invalid merchant-identifier
2. Non-existent valid security association with merchant
3. Merchant hash mismatch
4. Invalid order-confirmation-number

At 1570, the auto_buy engine 222 communicates with purchase application 242 whether the proxy purchase was successful or not. For an automated payment, the auto_pay engine 226 sends a transaction-identifier or a variation to the purchase application 242 as a payment-confirmation-number if the payment was successful; an error code otherwise. For an automated purchase, the auto_buy engine 222 sends a purchase-identifier or a variation to the purchase application 242 as a purchase-confirmation-number if the purchase was successful; an error code otherwise. The purchase application 242 produces Web pages with appropriate forms, confirmation numbers, error codes and other information for user review.

### Proxy Shipment and Shipping Notification Methods.

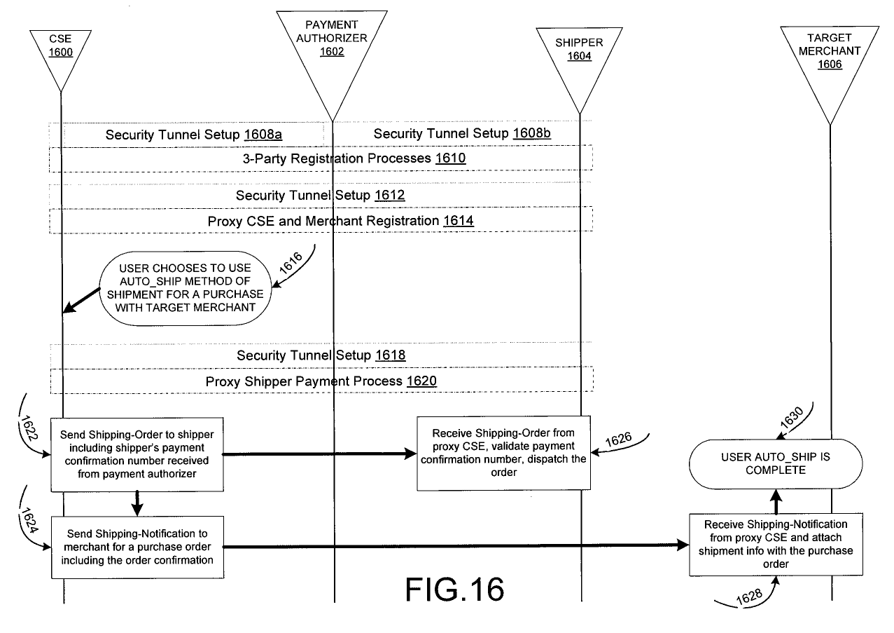

Reference is now made to FIG. 16, which illustrates a simplified flowchart of an example proxy shipment and shipment ordering methods and protocol described as at least one aspect of the presented system. The protocol includes four entities: a CSE 1600, a payment authorizer 1602, a shipper 1604 and a merchant 1606 all operating in accordance to at least one aspect of the presented system. The boxes 1608, 1612 and 1618 are security tunnel setups similar to boxes 1506 and 1508 described as part of FIG. 15a and FIG. 15b description above. The box 1610 illustrates a CSE<>payment-authorizer and shipper<>payment-authorizer registration methods and is similar to box 1510 described as part of FIG. 15a description above where a ‘shipper’ replaces the ‘merchant’. The box 1614 comprises the CSE<>shipper registration and CSE<>payment authorizer shipper confirmation and is similar to box 1526 described as part of FIG. 15b description above where a ‘shipper’ replaces the ‘merchant’. The box 1620 comprises the shipping order reservation and proxy payment process and is similar to box 1542 described as part of FIG. 15c description above where a ‘shipper’ replaces the ‘merchant’ and ‘shipping-order’ replaces ‘order’. Proxy shipment methods and protocols are carried on the auto_ship engine 228.

At 1622, CSE 1500 sends Shipment-Request message to the shipper 1604. The message includes proxy-identifier, shipping-order-confirmation-number (shipper provided), shipper-confirmation-number (payment authorizer provided), amount and proxy-hash. Auto_ship engine 228 on CSE 1600 stores the pending-shipping-order in its pending-shipping-order-table with {user, merchant, shipper} and shipping-order-confirmation-number as the key. At 1626, the shipper 1604 receives the Shipment-Request message. The shipper 1604 first looks up the proxy in its proxy-table using proxy-identifier. If a valid proxy is found and a valid proxy-hash exists, it is matched against the proxy-hash received in the message. If a match is found, the shipping-order-confirmation-number is used to lookup the reserved-shipping-order-table. If a reserved-shipping-order is found in this table, the proxy-identifier stored in this entry is matched against the proxy-identifier received in the message. If a match is found, the shipper-confirmation-number is used to lookup the transaction from the transaction-table. If a valid transaction is found, the shipment order is accepted. The shipping-order-details from the reserved-shipping-order and transaction-details from the transaction is used to create a confirmed-shipping-order into an shipping-order-table by the shipper 1604. Any of the following error conditions result in the shipper 1604 to silently discard a request (at least one error condition may indicate possible security breach and fraudulent activities):
1. Invalid proxy-identifier
2. Non-existent valid security association with proxy
3. Proxy hash mismatch
4. Invalid shipping-order-confirmation-number
5. Proxy-identifier mismatched in shipping-order-confirmation-number
6. Invalid shipper-confirmation-number
7. Amount mismatch between payment authorization and shipment order

While it is possible to use proxy shipment method for placing automated shipment orders without any associated merchant, an automated order placed through a CSE 1600 sends a Shipping-Notification message to the merchant at 1624. The message includes order-confirmation-number, shipping-order-confirmation-number, shipper-details, proxy-hash. At 1628, merchant 1606 receives the notification and first it performs similar checks as performed at step 1566 described as part of FIG. 15d description above. Once the checks are passed, the order-confirmed-number is used to lookup the confirmed-order in order-table and shipping-order-confirmation-number and shipper-details is stored as part of the confirmed-order. Subsequently, the purchased item is handed over to the shipper for delivery to the buyer.

At 1630, the auto_ship engine 228 communicates with purchase application 242 whether the proxy shipment was successful or not. For an automated shipment, the auto_ship engine 228 sends a shipment-identifier or a variation to the purchase application 242 as a shipment-confirmation-number if the shipment was successful; an error code otherwise. The purchase application 242 produces Web pages with appropriate forms, confirmation numbers, error codes and other information for user review.

While proxy purchase, proxy payment and proxy shipment methods are illustrated above in automated buying, paying and shipping for online shopping, these methods may benefit general online purchase, payment and shipment placement through proxy service providers. The stringent security and confidentiality requirements of proxy online payment are addressed using message and sender authentications, double encryption for sensitive user and merchant information (a tunnel and partial message encryption) and digital signing using hash functions. These security methods are flexible for addressing a wide range of security needs of payment authorizers, merchants and users. For example, strong hash functions, e.g. HMAC-SHA256 and strong encryption algorithms, e.g. AES-256 with CMAC can be used for very high security requirements. On the other hand, medium-strength hash functions, e.g. HMAC-MD5 and medium strength encryption algorithms, e.g. 3DES can be used for medium security requirements.

Automated buying, paying and shipping is highly desirable and beneficial for users and merchants alike. These methods allow a user to purchase products and services from multiple E-tailers from a single CSE operating in accordance to one or aspects of an example embodiment and allow the CSE to obtain authorizations for each E-tailer for the appropriate amount and place purchase orders on behalf of the user to those E-tailers. These methods also allow a user to use a single shipper for all orders or a different shipper for each order or any combination thereof and pay for all shipments through the single CSE operating in accordance to one or aspects of an example embodiment. Further, the ability to place purchase orders and shipments through a single CSE allows users to manage their online shopping activities more effectively and efficiently.

1. An apparatus, comprising:
a first interface configured to communicate with a first and second vendor;
a user interface configured to receive data and output data; and
logic coupled to the first interface and the user interface;
wherein the user interface is configured to receive data representative of a first product to purchase from a first vendor and a second product to purchase from the second vendor;
wherein the logic is responsive to the received data to determine a total payment amount for the first product and the second product;
wherein the logic is responsive to determining the total to have the total output on the user interface; and
wherein the logic is responsive to receiving payment data from the user interface to distribute a payment to the first vendor and the second vendor.

2. The apparatus of claim 1, wherein the first product comprises a first plurality of products to purchase from the first vendor and the second product comprises a second plurality of items to purchase from the second vendor.

3. The apparatus of claim 2, wherein the logic is configured to calculate a first subtotal for the first plurality of products and a second subtotal for the second plurality of products

4. The apparatus of claim 3, wherein the logic is configured to output the first and second subtotals via the user interface.

5. The apparatus of claim 1, wherein the communication interface is further configured to communicate with a shipping vendor;
wherein the logic is further configured to receive data from the user input for shipping the first and second products to a location; and
wherein the logic communicates data for shipping the first product and the second product to the location to the shipping vendor.

6. The apparatus of claim 5, wherein the logic is configured to receive a confirmation from the shipping vendor.

7. The apparatus of claim 6, wherein the logic is configured to communicate the confirmation to the first vendor and the second vendor.

8. An apparatus, comprising:
a first interface configured to communicate with a first and second product vendors and first and second shipping vendors;
a user interface configured to receive data and output data; and
logic coupled to the first interface and the user interface;
wherein the logic is configured to receive data from the user interface representative of a first product to purchase from a first vendor and a second product to purchase from a second vendor;
wherein the logic is configured to output on the user interface to data representative of the first shipping vendor and the second shipping vendor;
wherein the logic is configured to receive data representative of a user selection of a selected shipping vendor selected from the group consisting of the first shipping vendor and the second shipping vendor;
wherein the logic is further configured to receive data from the user input for shipping the first and second products to a location; and
wherein the logic communicates data for shipping the first product and the second product to the location to the shipping vendor.

9. The apparatus of claim 8, wherein the logic is configured to acquire a first cost for shipping the first and second items from the first shipping vendor and a second cost for shipping the first and second items from the second shipping vendor; and
wherein the logic is responsive to acquiring the first cost and second cost to output the first cost and second cost on the user interface.
wherein the logic communicates data for shipping the first product and the second product to the location to the shipping vendor.

10. The apparatus of claim 9, wherein the logic is configured to receive a confirmation from the shipping vendor.

11. The apparatus of claim 10, wherein the logic is configured to communicate the confirmation to the first vendor and the second vendor.

12. An apparatus, comprising:
a first interface configured to communicate with a first and second vendor;
a user interface configured to receive data and output data; and
logic coupled to the first interface and the user interface;
wherein the logic is configured to receive data from the user interface representative of a product and an optimization parameter;
wherein the logic is configured to communicate with the first vendor to acquire first product data associated with the product available from the first vendor;
wherein the logic is configured to communicate with the first second to acquire second product data associated with the product available from the second vendor; and
wherein the logic is configured to filter the first and second product data based on data representative of an optimization parameter received via the user interface.

13. The apparatus of claim 12, wherein the logic is configured to receive data from the user interface representative of a duration and frequency for the search; and
wherein the logic is responsive to perform the search at the specified frequency for the duration of the search.

14. The apparatus of claim 12, wherein the logic is configured to receive data from the user interface for outputting the data.

15. The apparatus of claim 12, further comprising:
a web interface in communication with the logic;
a storage device in communication with the logic;
wherein the logic is configured to store the first and second product data on the storage device;
wherein the first and second product data are provided via the web interface.

16. The apparatus of claim 12, wherein the optimization parameter is one of a group selected from a reliability index, a safety index cost, brand, a reputation index, brand review, a user interest, a popularity index and a planned purchase.

17. The apparatus of claim 12, wherein the optimization parameter is a popularity index based on a number of searches for the Product divided by Total searches for all Products within a product category, plus a number of browses for the Product divided by a Total number of browses for all Products within the product category, plus a number of positive reviews for the Product divided by a total number of positive reviews for all Products within the product category, plus a number of recommendations for the Product divided by a number of total recommendations for all Products within the product category) minus a number of negative reviews for the Product divided by a number of total negative reviews for all Products within the product category

18. A system for secure online proxy payments, comprising:
a merchant device;
a payment-authorizer device; and
a proxy device;
wherein the merchant device sends a merchant Registration-Request to the payment-authorizer device, the merchant Registration-Request including merchant-credentials;
wherein the payment-authorizer device sends a merchant-key to the merchant device in a merchant Registration-Response;
wherein the proxy device sends a proxy Registration-Request to the payment-authorizer device, the proxy Registration-Request comprises proxy-credentials;
wherein the payment-authorizer device sends a proxy-key in a proxy Registration-Response to the proxy device;
wherein the merchant device sends a merchant-proxy Registration-Request to the proxy device, the merchant-proxy Registration-Request comprises a merchant-hash;
wherein the proxy device sends a proxy-hash to the merchant device in a Registration-Response;
wherein the proxy device sends a Merchant-Request to the payment-authorizer device that comprises a merchant-hash encrypted using the proxy-key; and
wherein the proxy device receives a proxy-merchant-key from the payment-authorizer device in a Merchant-Response.

19. The system of claim 18, wherein:
the proxy device sends an Order-Request for a product to the merchant device, the Order-Request comprises the proxy-hash;
the proxy device receives a order-confirmation-number in Order-Response from the merchant device that includes the merchant-hash;
the proxy device sends a Payment-Request to the merchant device encrypted with the proxy-merchant key;
the proxy device receives a Payment-Response containing payment-authorization information, encrypted using proxy-merchant-key; wherein the Payment-Response contains both a proxy-confirmation-number and a merchant-confirmation-number
the Payment-authorizer device sends a Payment-Notification to the merchant device, the Payment-Notification comprises merchant-confirmation-number encrypted with the merchant-key;
the proxy device sends a Purchase-Order including the order-confirmation-number and the merchant-confirmation-number received and the merchant-hash; and
the merchant device receives the Purchase-Order, processes the Purchase-Order, validates the order-confirmation-number and the merchant-confirmation-number, and sends a Purchase-Confirmation to the proxy device.

20. The system of claim 19, further comprising a shipping device, wherein:
the proxy device sends a Shipping-Order to a shipper including receiver information, merchant information, and a shipping-order-confirmation-number and a shipper-hash to the sipping device;
the proxy device sends a Shipping-Notification to the merchant, the Shipping-Notification comprises an order-confirmation-number, shipper information, a shipping-order-confirmation-number and the merchant hash.
